(19) United States
(12) Patent Application Publication
(10) Pub. No.: US 2007/0195881 A1
(43) Pub. Date: Aug. 23, 2007

(54) Motion vector calculation apparatus

(75) Inventor: Taro Hagiya, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/443,373

(22) Filed: May 31, 2006

(30) Foreign Application Priority Data
Feb. 20, 2006 (JP) 2006-042400

(51) Int. Cl. H04N 7/12; H04N 11/04; H04N 11/02

(52) U.S. Cl. 375/240.14; 375/240.15; 375/240.16

(57) ABSTRACT

In accordance with control signals input by a P-picture control unit to a common circuits, the common circuits read image data of a calculation region to perform a full retrieving process of the image data. A motion vector is calculated by comparing a smallest SAD and a motion vector calculated in a full retrieving process that are output from each of the common circuits.

### CROSS-REFERENCE TO RELATED APPLICATIONS

This application is based upon and claims the benefit of priority from the prior Japanese Patent Application No. 2006-042400, filed on Feb. 20, 2006, the entire contents of which are incorporated herein by reference.

### BACKGROUND OF THE INVENTION

1. Field of the Invention

The present invention relates to a technology for performing a motion vector calculation on a plurality of frame images in moving image compression.

2. Description of the Related Art

Conventionally, in data compression of a moving image constituted by plural frame images, a compression coding method, such as a moving picture experts group phase 2 (MPEG-2), an MPEG-4, and H.264, has been used. In such compression coding method, a time difference between the frame images is used to compress a data amount.

In these compression coding methods, compression is performed using frame images obtained by three compression methods, an intra-picture (I-picture), which is an intra-frame coded picture, a bidirectionally-predictive picture (B-picture), which is a bidirectionally-predictive coded picture, and a predictive picture (P-picture), which is a forward-predictive coded picture.

The I-picture is a frame image that is coded while performing motion compensation in a frame image without referring to any other frame image for a compression target frame image.

The B-picture is a frame image obtained by coding a compression target frame while performing motion compensation with respect to frame images in both temporally forward and backward directions in a series of images. The motion compensation is achieved referring to the frame images in the forward and backward directions.

The P-picture is a frame image obtained by coding a compression target frame image while performing motion compensation with respect to a frame image in the temporally forward direction in a series of frame images. The motion compensation is achieved referring to a frame image in the forward direction.

FIG. 1 is a schematic of the I-picture, B-picture, and P-picture. In FIG. 1, an I-picture 1901, a B-pictures 1902, 1903, and a P-picture 1904 are arranged along a flow of time shown by an arrow 1910.

The I-picture 1901 s processed by intra-frame image coding without referring to any other frame image (hereinafter, “picture”) is provided periodically to compress and reproduce images of other picture types such as the B-pictures 1902, 1903 and the P-picture 1904.

The I-picture 1901 has a lower coding efficiency and a larger amount of generated information than inter-frame coding that uses a difference between frame images for coding. The coding efficiency indicates a correlation between image quality and a data amount, and the coding efficiency will be increased when a smaller coded data amount is obtained for the same image quality, or when the same coded data amount is obtained for a higher image quality.

The B-pictures 1902, 1903 are compressed by inter-frame coding utilizing a motion vector calculated based on two coded pictures. Specifically, the B-pictures 1902, 1903 are coded referring to the I-picture 1901, which is a temporally past frame image, and the P-picture 1904, which is a future frame image.

Since the B-pictures 1902, 1903 refer to pictures in two directions, which are the temporally forward and backward directions, even if an object appears in the middle, accurate prediction can be made to enhance the coding efficiency. On the other hand, since the B-pictures 1902, 1903 refer to the P-picture 1904, which is a temporally future frame image, the B-pictures 1902, 1903 are coded after coding the P-picture 1904, and are arranged in order of time. When a real time processing is required, the number of insertions is limited. The B-pictures 1902, 1903 are not referred by other pictures.

The P-picture 1904 is compressed by inter-frame coding utilizing a motion vector calculated based on one temporally past coded picture. Specifically, the P-picture is coded referring to the I-picture 1901, which is a frame image in the temporally forward direction. The picture type of images referred by the P-picture 1904 should be I or P.

Although three compression methods for each frame image are described in the description of FIG. 1, the unit of compression is not limited to each frame image, and may be each block or field in a frame image.

FIG. 2 is a schematic of a conventional motion vector calculation apparatus for the P-picture. As shown in FIG. 2, a motion vector calculation apparatus 2000 includes a control unit 2011, an external memory interface 2030, a cache memory 2012, and a calculating unit 2013.

The control unit 2011 controls the motion vector calculation apparatus 2000 and outputs to the external memory interface 2030 an acquisition request for image data that will be a calculation region from a reference image.

The reference image is, for example, a frame image in the temporally forward direction from a source image and a frame image of the I or P picture type. The source image is a block of 16×16 pixels (hereinafter, “macroblock”) in a compression target frame image.

The calculation region is a region in the reference image where image information corresponding to the compression target source image is calculated. The image information includes an amount of change in pixel values of one macroblock in the source image and the reference image and is calculated for a predetermined calculation region in the reference image.

The control unit 2011 calculates a motion vector for generating the P-picture of the source image based on a result of calculation by the calculating unit 2013, and outputs the motion vector to an external apparatus not shown. Specifically, the control unit 2011 retrieves a macroblock that has a small amount of change in the pixel values of the source image and the reference image. Based on a positional relationship between the retrieved macroblock and the macroblock when motion of the source image is zero in the reference image, a motion between the source image and the reference image is predicted. Thus, the motion vector is calculated. For example, the external apparatus refers to the motion vector input from the control unit 2011 and performs a coding process of the source image to generate the P-picture.

The external memory interface 2030 performs a data request for the image data of the calculation region to an external memory 2050 in accordance with a request input from the control unit 2011.

The external memory 2050 stores a series of frame images constituting a moving image and outputs the image data of the calculation region to the cache memory 2012 in accordance with the data request from the external memory interface 2030.

The cache memory 2012 temporarily stores the image data input from the external memory 2050. The image data stored temporarily are output to the calculating unit 2013 under the control of the control unit 2011.

The calculating unit 2013 refers to the image data of the compression target source image and the image data of the calculation region stored in the cache memory 2012 to calculate the image information of the source image and the calculation region. The calculating unit 2013 outputs the calculated image information to the control unit 2011 as a result of calculation.

FIG. 3 is a schematic of a conventional motion vector calculation apparatus for the B-picture. As shown in FIG. 3, a motion vector calculation apparatus 2100 includes two common circuits 2110, 2120, an external memory interface 2130, and a bidirectional control unit 2140. The common circuits 2110, 2120 are constituted by control units 2111, 2121, cache memories 2112, 2122, and calculating units 2113, 2123, respectively.

The motion-vector calculation apparatus 2100 uses a frame image of the I or P picture type that is a frame image in the temporally forward and backward directions from the compression target source image, for the reference image to calculate a motion vector.

The bidirectional control unit 2140 controls the control units 2111, 2121 to generate a motion vector that is a generation source of the B-picture. Specifically, the bidirectional control unit 2140 requests the control units 2111, 2121 to use a frame image in the temporally forward direction and a frame image in the temporally backward direction from the source image for the reference images, respectively.

The bidirectional control unit 2140 calculates a motion vector for generating the B-picture of the source image based on the results of calculation input from the control units 2111, 2121, and outputs the motion vector to an external apparatus not shown. Specifically, The bidirectional control unit 2140 retrieves, from among the results of calculation, a macroblock that has a small amount of change in the pixel values of the source image and the reference image. Based on a positional relationship between the retrieved macroblock and the macroblock when a motion of the source image is zero in the reference image, a motion between the source image and the reference image is predicted. Thus, the motion vector is calculated.

The motion between the source image and the reference image may be predicted based on an average of the results of calculation input from the control units 2111, 2121. For example, the external apparatus refers to the motion vector input from the bidirectional control unit 2140 and performs a coding process of the source image to generate the B-picture.

The control units 2111, 2121 output to the external memory interface 2130 acquisition requests for image data to be a calculation region in a reference image.

For example, the control unit 2111 outputs as an acquisition request for image data of a calculation region in a frame image in the temporally forward direction from the source image. The control unit 2121 outputs as an acquisition request for image data of a calculation region in a frame image in the temporally backward direction from the source image. Specifically, the calculation region is a region in the reference image where image information corresponding to the compression target source image is calculated.

The control units 2111, 2121 output to the bidirectional control unit 2140 the results of calculation by the calculating units 2113, 2123 for the image information.

The image information is information that is a calculation source of the motion vector in the source image and is, for example, an amount of change in pixel values of a macroblock in the source image and the reference image. The calculating units 2113, 2123 may output to the bidirectional control unit 2140 a result of calculation having a smaller amount of change in the pixel values from among the results of calculation by the calculating units 2113, 2123.

The external memory interface 2130 performs a data request for the image data of the calculation region to an external memory 2150 in accordance with a request input from the control units 2111, 2121.

The external memory 2150 stores a series of frame images constituting a moving image and outputs the image data of the calculation region to the cache memories 2112, 2122 in accordance with the data request from the external memory interface 2130.

The cache memories 2112, 2122 temporarily store the image data input from the external memory 2150. The image data stored temporarily are output to the calculating units 2113, 2123 under the control of the control units 2111, 2121.

The calculating units 2113, 2123 refer to the image data of the compression target source image and the image data of the calculation region stored in the cache memories 2112, 2122 to calculate the image information of the source image and the calculation region. The calculating units 2113, 2123 outputs the calculated image information to the control unit 2111, 2121 as the results of calculation.

As described in FIGS. 2 and 3, the calculation of the motion vector for generating the P-picture and the calculation of the motion vector for generating the B-picture are different only in that a frame image used for the reference image is in the forward direction or the backward direction from the source image.

Therefore, the control units 2011, 2111, 2121, the cache memories 2012, 2112, 2122, and the calculating unit 2013, 2113, and 2123 have almost the same configurations, and conventionally, the motion vector for generating the P-picture and the motion vector for generating the B-picture have been calculated using the configuration of the motion vector calculation apparatus 2100.

FIG. 4 is a schematic of a conventional motion vector calculation apparatus for the P-picture and the B-picture. As shown in FIG. 4, a motion vector calculation apparatus 2200 includes a selecting unit 2201, two common circuits 2110, 2120, the external memory interface 2130, and the bidirectional control unit 2140.

The common circuits 2110, 2120 includes control units 2111, 2121, cache memories 2112, 2122, and calculating units 2113, 2123, respectively. In the motion vector calculation apparatus 2200, the same numerals are added to components having almost the same function as FIG. 3 described above and the description thereof is omitted.

Since the motion vector calculation apparatus 2200 performs the calculation of the motion vector for generating the P-picture and the calculation of the motion vector for generating the P-picture, the motion vector calculation apparatus 2200 accepts input of a P/B-picture switching signal 2202 for switching the calculations of the motion vectors for generating the P-picture and the B-picture from an external apparatus not shown.

The P/B-picture switching signal 2202 input from the external apparatus is input to the bidirectional control unit 2140, the control unit 2121, and the selecting unit 2201, and the motion vector calculation apparatus 2200 calculates the motion vector for generating the P-picture or the B-picture in accordance with the input P/B-picture switching signal 2202.

In accordance with the P/B-picture switching signal 2202, the selecting unit 2201 selects the motion vector for generating the P-picture or the motion vector for generating B-picture from the motion vector input from the control unit 2111 or the bidirectional control unit 2140 and outputs the motion vector to an external apparatus not shown.

Since the compression of the moving image constituted by a series of frame images is performed with the I-picture, B-picture, and the P-picture, it is desirable to promote efficiency of the motion vector calculation for generating each picture type.

Recently, in a moving image compression method and apparatus that retrieve the motion vector, the retrieve process is simplified by determining an optimum motion vector in the middle stage of the retrieving of the motion vector. It has been proposed that the motion vector is retrieved efficiently by averaging retrieve process amounts due to differences in the picture types (for example, Japanese Patent Application Laid-Open Publication No. H9-130808).

However, in the above conventional technology, since the B-picture is arranged between the I-picture and the P-picture, or between the P-picture and the P-picture, the reference image of the P-picture is a temporally distant image as compared to the reference image of the B-picture. Since the moving distance is increased when a temporally distant image is used for the reference image, the motion vector in the P-picture is greater than the B-picture.

The calculation of the motion vector of the P-picture is performed, for example, by using either the common circuit (R) 2110 or the common circuit (L) 2120 used to calculate the motion vector of the B-picture. Therefore, if the common circuit (R) 2110 and the common circuit (L) 2120 have processing abilities suitable for calculating the motion vector in the B-picture, the calculation region in the B-picture is equal to the calculation region in the P-picture.

Therefore, since a sufficient calculation region cannot be ensured for the P-picture that has a larger vector, the accuracy of the P-picture is significantly degraded. If the accuracy of the P-picture is degraded, accuracy is also degraded in the B-picture that uses the P-picture for the reference image. Therefore, the image quality is deteriorated in the entire moving image.

On the other hand, if the common circuit (R) 2110 and the common circuit (L) 2120 have processing abilities suitable for calculating the motion vector in the P-picture, the calculation region in the B-picture is equal to the calculation region in the P-picture.

Therefore, since a calculation region becomes greater for the B-picture that has a smaller vector, the generation of the P-picture is delayed due to unnecessary processes. Since the lack of the insertion of the B-picture means the lack of a picture using a future frame for the reference image, the image quality is deteriorated in the entire moving image because appearance of an object in the moving image cannot be accommodated.

### SUMMARY OF THE INVENTION

It is an object of the present invention to solve at least the above problems in the conventional technologies.

A motion vector calculation apparatus according to one aspect of the present invention calculates a motion vector of a source image in a series of frame images constituting a moving image, based on the source image and at least one reference image that includes a forward image being a frame image positioned temporally forward and a backward image being a frame image positioned temporally backward to the source image in the series of the frame images. The motion vector calculation apparatus includes a first calculating unit configured to calculate first information based on the source image and the forward image; a second calculating unit configured to calculate second information based on the source image and the backward image; a switching unit configured to switch the reference image from a bidirectional images including both the forward image and the backward image, to only the forward image. The second calculating unit is configured to calculate, when the reference image is switched by the switching unit, third information based on the source image and the forward image, the third information being different from the first information.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an I-picture, a B-picture, and a P-picture;

FIG. 2 is a schematic of a conventional motion vector calculation apparatus for the P-picture;

FIG. 3 is a schematic of a conventional motion vector calculation apparatus for the B-picture;

FIG. 4 is a schematic of a conventional motion vector calculation apparatus for the P-picture and B-picture;

FIG. 5A is a schematic of a source image in motion vector calculation according to a first embodiment of the present invention;

FIG. 5B is a schematic of a smallest sum of absolute difference (SAD) calculation range in the motion vector calculation according to the first embodiment;

FIG. 6A is a schematic for illustrating a full retrieving method according to the first embodiment;

FIG. 6B is a schematic for illustrating the full retrieving method according to the first embodiment;

FIG. 6C is a schematic for illustrating the full retrieving method according to the first embodiment;

FIG. 6D is a schematic for illustrating the full retrieving method according to the first embodiment;

FIG. 6E is a schematic for illustrating the full retrieving method according to the first embodiment;

FIG. 6F is a schematic for illustrating the full retrieving method according to the first embodiment;

FIG. 7 is a schematic of a motion vector calculation apparatus according to the first embodiment;

FIG. 8 is a schematic of a calculation region for calculating the SAD corresponding to the source image according to the first embodiment;

FIG. 9 is a flowchart of a motion vector calculation process by the motion vector calculation apparatus according to the first embodiment;

FIG. 10 is a flowchart of a full retrieving process by the motion vector calculation apparatus according to the first embodiment;

FIG. 11A is a schematic for illustrating a track retrieving method according to the first embodiment;

FIG. 11B is a schematic for illustrating the track retrieving method according to the first embodiment;

FIG. 11C is a schematic for illustrating the track retrieving method according to the first embodiment;

FIG. 11D is a schematic for illustrating the track retrieving method according to the first embodiment;

FIG. 12 is a flowchart of the track retrieving method shown in FIGS. 11A to 11D;

FIG. 13 is a schematic for illustrating SAD calculation in the track retrieving method by the motion vector calculation apparatus according to a second embodiment of the present invention;

FIG. 14 is a flowchart of a motion vector calculation process by the motion vector calculation apparatus according to the second embodiment;

FIG. 15 is a schematic of a motion vector calculation apparatus according to a third embodiment of the present invention;

FIG. 16 is a schematic of a calculation region for calculating the SAD corresponding to the source image according to the third embodiment;

FIG. 17 is a flowchart of a motion vector calculation process by a motion vector calculation apparatus according to the third embodiment;

FIG. 18 is a schematic of a motion vector calculation apparatus according to a fourth embodiment of the present invention;

FIG. 19 is a schematic of a calculation region for calculating the SAD corresponding to the source image according to the fourth embodiment;

FIG. 20 is a schematic of a motion vector calculation apparatus according to a fifth embodiment of the present invention;

FIG. 21 is a schematic of a calculation region for calculating the SAD corresponding to the source image according to the fifth embodiment; and

FIG. 22 is a flowchart of a motion vector calculation process by the motion vector calculation apparatus according to the fifth embodiment.

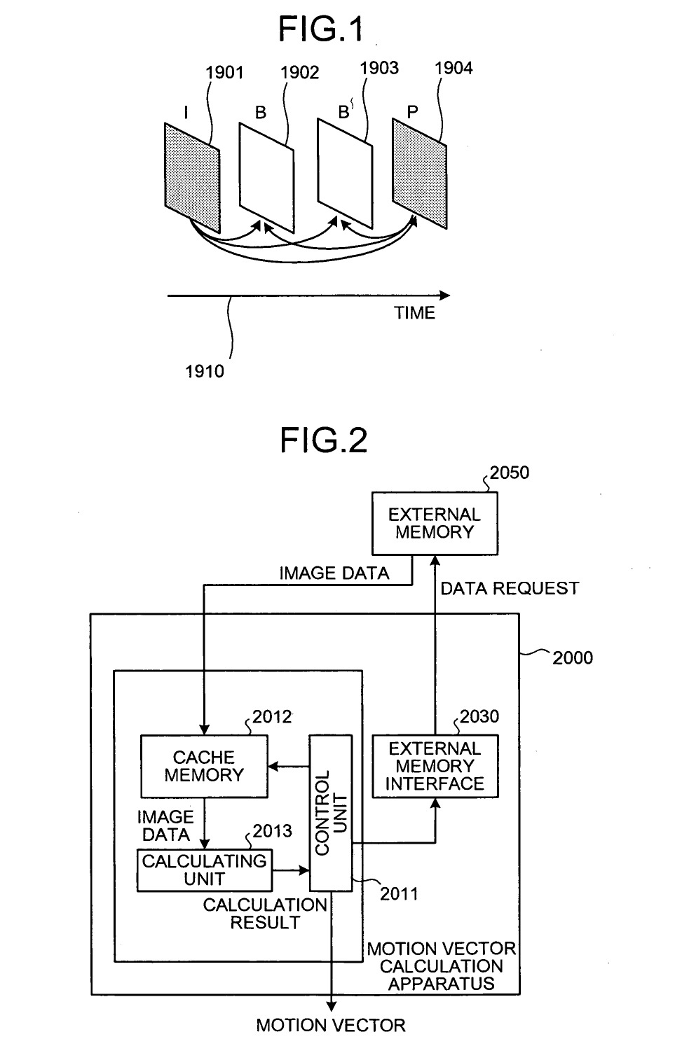

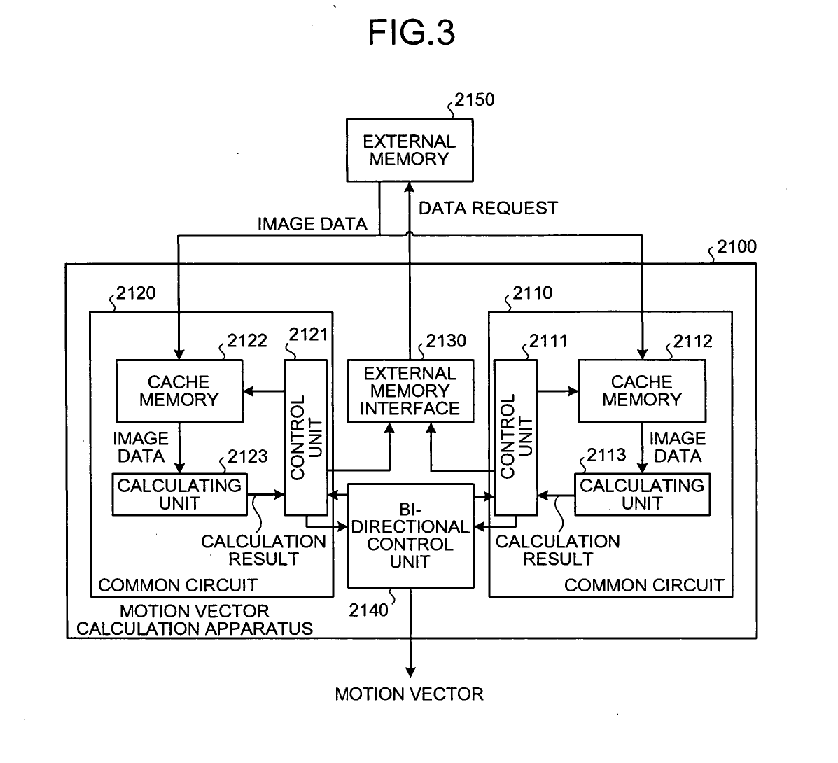

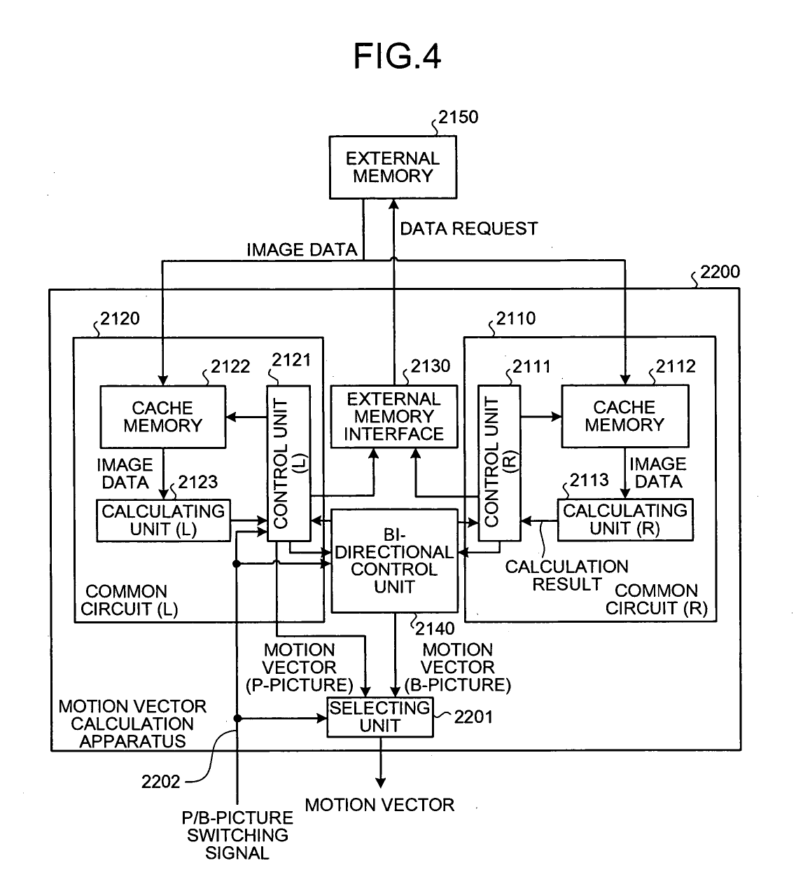

### DETAILED DESCRIPTION OF THE PREFERRED EMBODIMENTS

Exemplary embodiments according to the present invention will be explained in detail below with reference to the accompanying drawings.

A motion vector calculation apparatus according to a first embodiment of the present invention calculates a SAD between a source image and a reference image for image information to calculate an optimum motion vector for a compression target source image.

Specifically, a position of a SAD calculation range is retrieved which has a smallest SAD between one macroblock of the source image and a SAD calculation range within a predetermined calculation region in the reference image. A motion vector is determined from a relationship between the retrieved position of the SAD calculation range and a position when the motion of the source image is zero in the reference image.

The SAD calculation range has a range equal to the source image and is, for example, one macroblock in the first embodiment. The SAD is a sum of absolute values of pixel values compared one-by-one between one macroblock of the source image and one macroblock of the SAD calculation range within the calculation region.

The compression target source image may be an image included in P-pictures or B-pictures in compression of a moving image constituted by a series of frame images, and in the first embodiment, it is assumed that the compression target source is an image included in the P-pictures. The reference image is a P-picture or I-picture that is temporally earlier than and different from the source image.

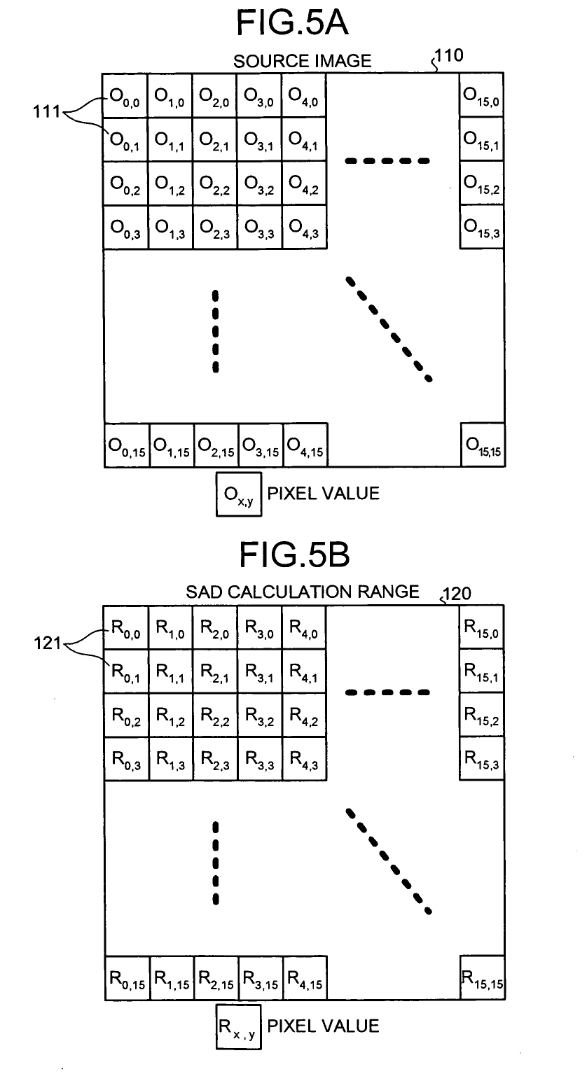

FIG. 5A is a schematic of the source image in the motion vector calculation according to the first embodiment. In the example shown in FIG. 5A, a source image 110 is constituted by one macroblock of 16×16 pixels and a pixel value of each pixel 111 is O_{x,y}. A position in the source image is indicated by numbers x and y, which are integers from 0 to 15.

FIG. 5B is a schematic of the SAD calculation range in the motion vector calculation. In the example shown in FIG. 5B, a SAD calculation range 120 is constituted by one macroblock of 16×16 pixels and a pixel value of each pixel 121 is R_{x,y}. A position in the SAD calculation range is indicated by numbers x and y, which are integers from 0 to 15. The SAD calculation range 120 is one arbitrary block within the calculation region in the reference image.

From FIGS. 5A and 5B described above, the sum SAD of the absolute values of the pixel values compared one-by-one can be expressed by the following Equation 1.

$$SAD = {\sum }_{y = 0}^{15} {\sum }_{x = 0}^{15} \vert Rx , y - Ox , y \vert \qquad ( 1 )$$

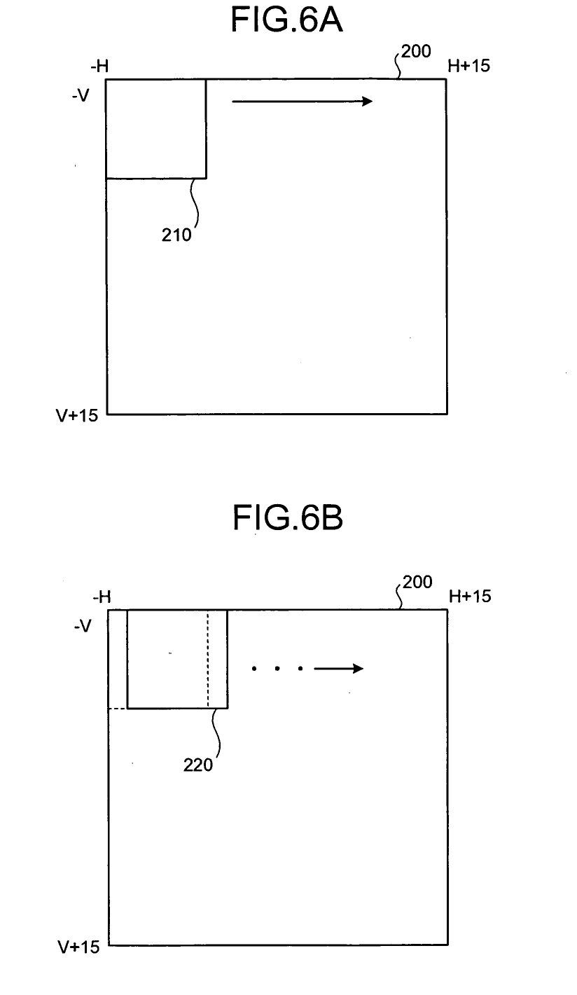

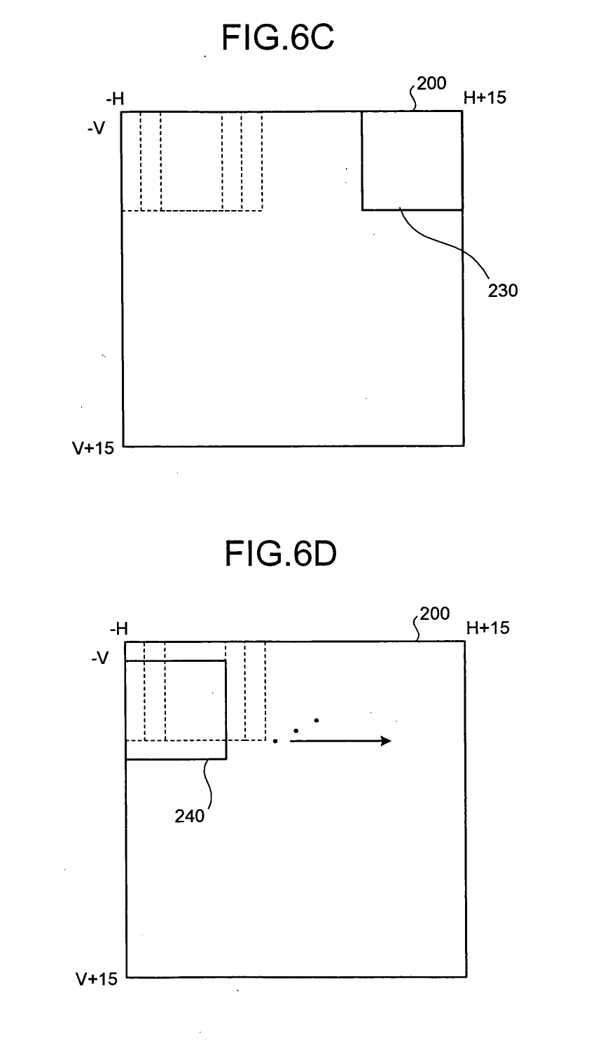

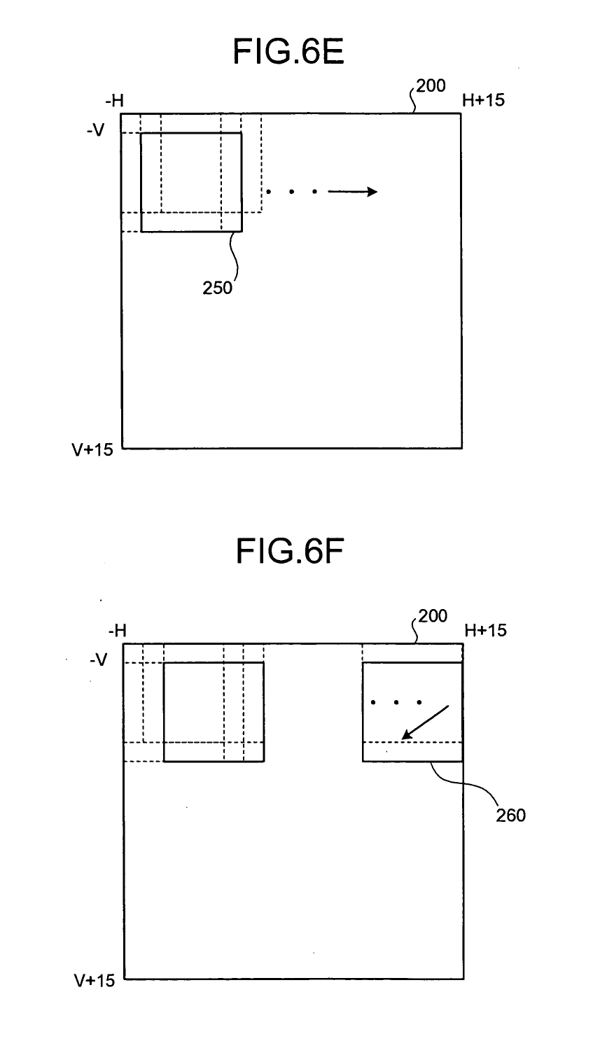

In the description of FIGS. 6A to 6F, the SAD is calculated by changing the SAD calculation range repeatedly within the calculation range such that the SAD is retrieved in the entire calculation region in the reference image. In this specification, a method of performing the retrieve in the entire calculation region is hereinafter referred to as a full retrieving method.

FIG. 6A is a schematic for illustrating the full retrieving method according to the first embodiment. As shown in FIG. 6A, a calculation region 200 is a range from −H to H+15 in the horizontal direction and from −V to V+15 in the vertical direction, and a calculation range 210 is set. The calculation range 210 is a range for calculating a SAD for the source image in the calculation region 200 and is located at the upper left of the calculation region 200 in FIG. 6A. Once the SAD is calculated in the calculation range 210, another calculation range 220 is set at a position moved by one pixel to the right in the horizontal direction, as described later in FIG. 6B.

Once the calculations are completed for all the SAD in the first row of the calculation region 200, another calculation range 240 is set at a position moved by one pixel downward in the vertical direction from the calculation range 210, as described later in FIG. 6D. Similarly, the setting of the calculation range is repeated to calculate the SAD for the entire calculation region 200.

FIG. 6B is a schematic for illustrating of the full retrieving method according to the first embodiment. As shown in FIG. 6B, in the calculation region 200, the calculation range 220 is set at a position shifted by one pixel to the right in the horizontal direction from the calculation range 210 illustrated in FIG. 6A. Once the SAD in the calculation range 220 is calculated, another calculation range is set at a position moved further to the right in the horizontal direction.

FIG. 6C is a schematic for illustrating the full retrieving method according to the first embodiment. As shown in FIG. 6C, the setting of the calculation range has been repeated in the calculation region 200 as described in FIGS. 6A and 6B, and a calculation range 230 is set that is the last calculation range in the first row of the calculation region 200 (upper right in the figure). The SAD in the calculation range 230 is calculated, and another calculation range is set at a position shifted by one pixel downward in the vertical direction from the calculation range 210 illustrated in FIG. 6A.

FIG. 6D is a schematic for illustrating the full retrieving method according to the first embodiment. As shown in FIG. 6D, in the calculation region 200, the calculation range 240 is set at a position shifted by one pixel downward in the vertical direction from the calculation range 210 illustrated in FIG. 6A. Once the SAD in the calculation range 240 is calculated, another calculation range 250 is set at a position shifted by one pixel to the right in the horizontal direction from the calculation range 240, as described later in FIG. 6E.

FIG. 6E is a schematic for illustrating the full retrieving method according to the first embodiment. In FIG. 6E, in the calculation region 200, the calculation range 250 is set at a position shifted by one pixel to the right in the horizontal direction from the calculation range 210 illustrated in FIG. 6D. Once the SAD in the calculation range 250 is calculated, another calculation range is set at a position moved further to the right in the horizontal direction.

FIG. 6F is a schematic for illustrating the full retrieving method according to the first embodiment. In FIG. 6F, the setting of the calculation range has been repeated in the calculation region 200 as described in FIGS. 6D and 6E, and a calculation range 260 is set that is the last calculation range in the second row of the calculation region 200 (right edge in the second row in the figure). The SAD in the calculation range 230 is calculated. The SAD in the calculation range 260 is calculated, and another calculation range is set at a position shifted by one pixel downward in the vertical direction from the calculation range 240 illustrated in FIG. 6D.

The process is repeated as described in FIGS. 6A to 6F to calculate the SAD of the entire calculation region, and the calculation range with the smallest SAD is obtained to calculate the motion vector of the source image. In other words, since the calculation range with a small amount of change from the source image is the macroblock in the reference image corresponding to the source image, the motion vector of the source image can be calculated from a positional relationship between the calculation range with a small amount of change and a macroblock when the motion of the source image in the reference image is zero.

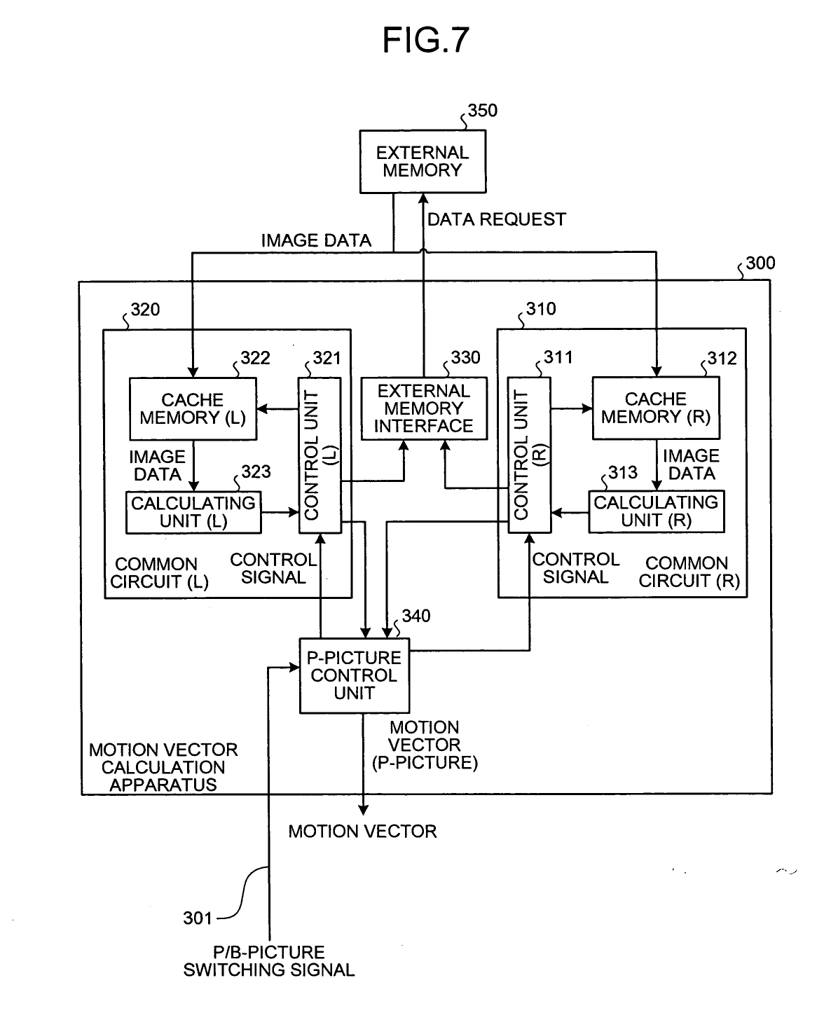

FIG. 7 is a schematic of the motion vector calculation apparatus according to the first embodiment. As shown in FIG. 7, a motion vector calculation apparatus 300 includes a common circuit (R) 310, a common circuit (L) 320, an external memory interface 330, and a P-picture control unit 340. The common circuit (R) 310 includes the control unit (R) 311, a cache memory (R) 312, and a calculating unit (R) 313. The common circuit (L) 320 includes a control unit (L) 321, a cache memory (L) 322, and a calculating unit (L) 323.

Although description will be made of the motion vector calculation apparatus 300 in relation to the calculation of the motion vector for generating the P-picture in the description of FIG. 7, the motion vector for generating the B-picture may be calculated by a bidirectional control unit not shown as is the case with the prior art.

The P-picture control unit 340 is responsible for the control for using the control unit (R) 311 and the control unit (L) 321 concurrently. Specifically, the P-picture control unit 340 accepts input of a P/B-picture switching signal 301 that switches the calculations of the motion vectors for generating the P-picture and B-picture from an external apparatus not shown.

In accordance with the input P/B-picture switching signal 301, the P-picture control unit 340 outputs control signals to the common circuit (R) 310 and the common circuit (L) 320. Specifically, if the motion vector for generating the P-picture is calculated, the reference image is controlled by the control signal so as to be switched from the frame images in both directions from the source image to only the forward frame image.

In other words, the control signal is a signal that requests each of the control unit (R) 311 and the control unit (L) 321 to use a frame image in the temporally forward direction from the source image for the reference image.

The P-picture control unit 340 uses calculation results input from the control unit (R) 311 and the control unit (L) 321 described later to calculate a motion vector for generating the P-picture in the source image and outputs the motion vector to an external apparatus not shown. Specifically, the motion vector of the source image is calculated by comparing the calculation results input from the control unit (R) 311 and the control unit (L) 321 and by identifying the destination of the source image in the forward frame image used as the reference image.

More specifically, a macroblock with a small amount of change from the source image is retrieved from the calculation results input from the control unit (R) 311 and the control unit (L) 321. The motion vector is calculated by predicting the motion between the source image and the reference image from the positional relationship between the retrieved macroblock and a macroblock when the motion of the source image in the reference image is zero. For example, the external apparatus refers to the motion vector input from the P-picture control unit 340 and performs a coding process of the source image to generate the P-picture.

The control unit (R) 311 and the control unit (L) 321 output to the external memory interface 330 an acquisition request for image data that will be a calculation region from the reference image.

The image information is, for example, the SAD illustrated in FIG. 5. In the first embodiment, each of the control unit (R) 311 and the control unit (L) 321 outputs an acquisition request for the image data of the calculation region in the frame image in the temporally forward direction from the source image.

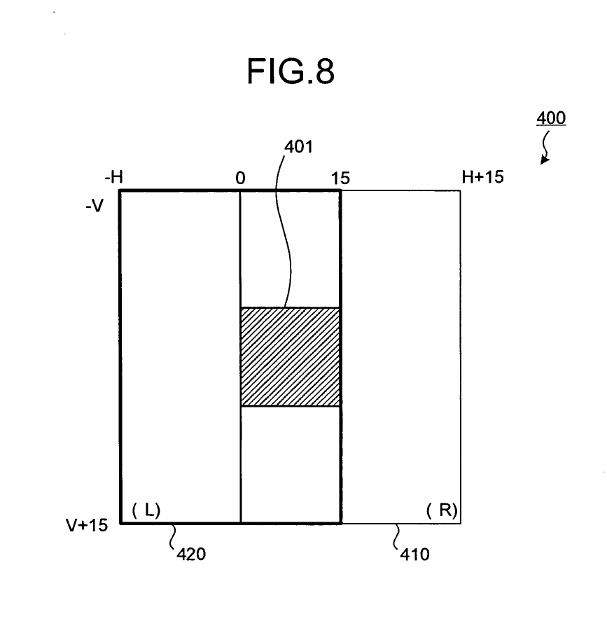

FIG. 8 is a schematic of the calculation region for calculating the SAD corresponding to the source image according to the first embodiment. As shown in FIG. 8, a calculation region 400 is constituted by a right calculation region (R) 410 and a left calculation region (L) 420.

The calculation region 400 is a region ranging from −H to H+15 in the horizontal direction and from −V to V+15 in the vertical direction, which is included in the reference image in the temporally forward direction from the source image, and the center location shows a calculation range 401 when the motion vector in the source image is zero.

The calculation range 401 is constituted by one macroblock of 16×16 pixels and is a range for calculating a sum SAD of the absolute values of the pixel values compared with the source image one-by-one. The calculation range 401 can be set at an arbitrary position in the calculation region 410 and will be described as a calculation range (X, Y) using the upper left position of the macroblock in this specification.

Specifically, in FIG. 8, a calculation range (0, 0) is the calculation range 401 when the motion vector in the source image is zero. When located at the upper left of the calculation region (L) 420, the calculation range 401 is a calculation range (−H, −V).

Both the calculation region (R) 410 and the calculation region (L) 420 include the calculation range 401 (calculation range (0, 0)) when the motion vector in the source image is zero. Specifically, the calculation region (R) 410 is a region ranging from 0 to H+15 in the horizontal direction and from −V to V+15 in the vertical direction, and the calculation region (L) 420 is a region ranging from −H to 15 in the horizontal direction and from −V to V+15 in the vertical direction.

Returning to FIG. 7, description will be made of the control unit (R) 311 and the control unit (L) 321. Each of the control unit (R) 311 and the control unit (L) 321 outputs an acquisition request for the image data of the calculation region to the external memory interface 330. Specifically, the control unit (R) 311 performs the acquisition request for the image data of the calculation region (R) 410 described above in FIG. 8. The control unit (L) 321 performs the acquisition request for the image data of the calculation region (L) 420 described above in FIG. 8.

Since the control unit (R) 311 and the control unit (L) 321 respectively perform the acquisition requests for the image data of the calculation region (R) 410 and the calculation region (L) 420, the SAD calculation region covers a wider range and the motion vector can be calculated more accurately. Especially, this is an effective technique for calculating the motion vector of the P-picture, which has a greater motion vector than the B-picture.

The control unit (R) 311 and the control unit (L) 321 output to the P-picture control unit 340 the image information for calculating the motion vector in the source image with the calculation results of the calculating unit (R) 313 and the calculating unit (L) 323 described later. The image information is, for example, the SAD illustrated in FIG. 5, and the minimum value of the SAD is output to the P-picture control unit 340 for each calculation result of the calculating unit (R) 313 and the calculating unit (L) 323.

The external memory interface 330 performs a data request for the image data of the calculation region to an external memory 350 in accordance with the requests input from the control unit (R) 311 and the control unit (L) 321. Specifically, the data request is performed for the image data of the calculating region (R) 410 illustrated in FIG. 8 and the image data of the calculating region (L) 420 illustrated in FIG. 8 for the common circuit 320.

The external memory 350 stores a series of frame images constituting a moving image, and outputs the image data of the calculation regions to the cache memory (R) 312 and the cache memory (L) 322 in accordance with the data request from the external memory interface 330. Specifically, the image data of the calculating region (R) 410 illustrated in FIG. 8 is output to the cache memory (R) 312. The image data of the calculating region (L) 420 illustrated in FIG. 8 is output to the cache memory (L) 322.

The cache memory (R) 312 and the cache memory (L) 322 temporarily store the image data input from the external memory 350. The image data stored temporarily are output to the calculating unit (R) 313 and the calculating unit (L) 323 under the control of the control unit (R) 311 and the control unit (L) 321.

The calculating unit (R) 313 and the calculating unit (L) 323 use the image data of the compression target source image and the image data of the calculation regions stored in the cache memory (R) 312 and the cache memory (L) 322 to calculate the image information that is a calculation source of the motion vector in the source image. The image information may be the SAD illustrated in FIG. 5, and the calculating unit (R) 313 and the calculating unit (L) 323 output the calculated SAD to the control unit (R) 311 and the control unit (L) 321.

Specifically, with regard to the calculating unit (R) 313, the SAD is calculated for all the calculation ranges (X, Y) in the calculation region (R) 410 of FIG. 8 by using the full retrieving method described in FIGS. 6A to 6F. The calculated SAD is output to the control unit (R) 311. In the first embodiment, X is in the range of 0 to H+15 and Y is in the range of −V to V+15.

As described above, in the motion vector calculation apparatus 300 shown in FIG. 7, the calculation region for calculating the SAD for the source image is divided in two and two common circuits, i.e., the common circuit (R) 310 and the common circuit (L) 320 share the calculation. Therefore, the SAD can be calculated from a wider calculation region without increasing the processing abilities of the common circuits and the motion vector can be calculated more accurately. Especially, this is an effective technique for calculating the motion vector of the P-picture, which has a greater motion vector than the B-picture.

Instead of calculating the SAD of the P-picture with only one common circuit (common circuit (R) 310 or common circuit (L) 320), the common circuits (common circuit (R) 310 and common circuit (L) 320) calculating the motion vector of the B-picture in a conventional configuration can be utilized to achieve the wider calculation region. Therefore, the circuit can be used efficiently in the calculation of the motion vector of the P-picture.

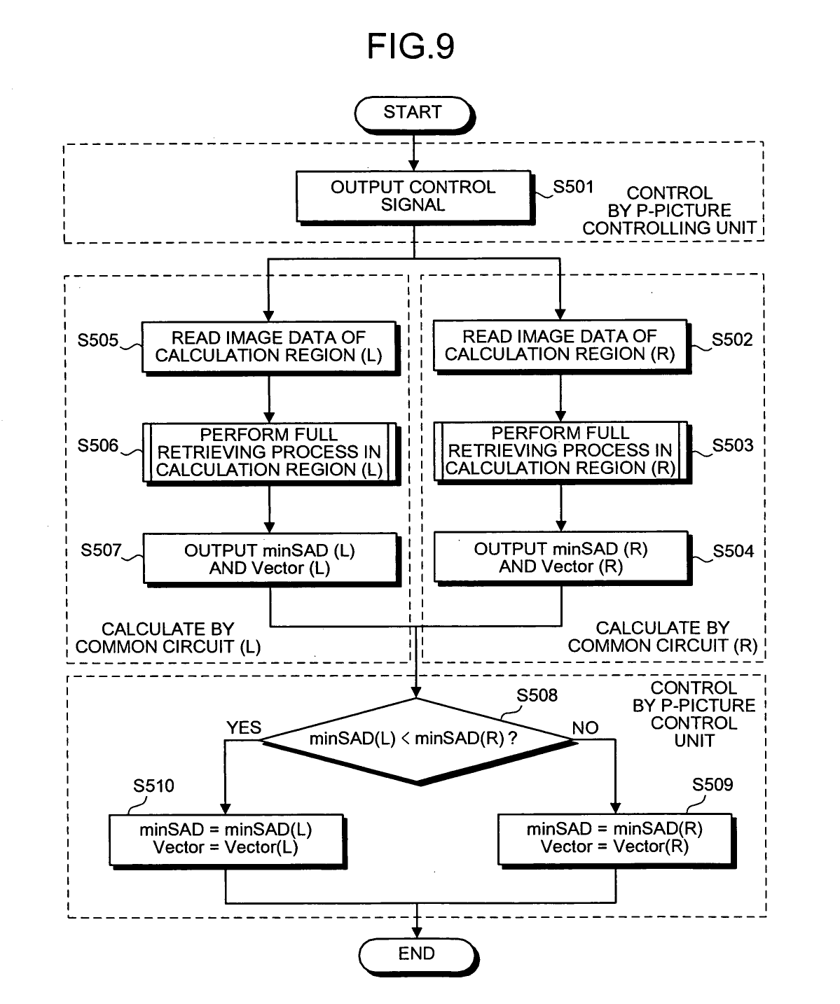

FIG. 9 is a flowchart of a motion vector calculation process by the motion vector calculation apparatus according to the first embodiment. The P-picture control unit 340 outputs control signals to the common circuit (R) 310 and the common circuit (L) 320 (step S501).

The control signals are signals to set the calculation regions and are, for example, signals that define the regions for calculating the SAD in the control unit (R) 311 and the control unit (L) 321 as the calculating region (R) 410 and the calculating region (L) 420 in the reference image in the temporally forward direction from the source image.

In accordance with the control signal input at step S501, the common circuit (R) 310 reads the image data of the calculating region (R) 410 from the external memory 350 (step S502). In the reading of the image data, specifically, the control unit (R) 311 performs an acquisition request for the image data of the calculating region (R) 410 to the external memory 350 through the external memory interface 330. The cache memory (R) 312 temporarily stores the image data of the calculating region (R) 410 input from the external memory 350 in accordance with the acquisition request.

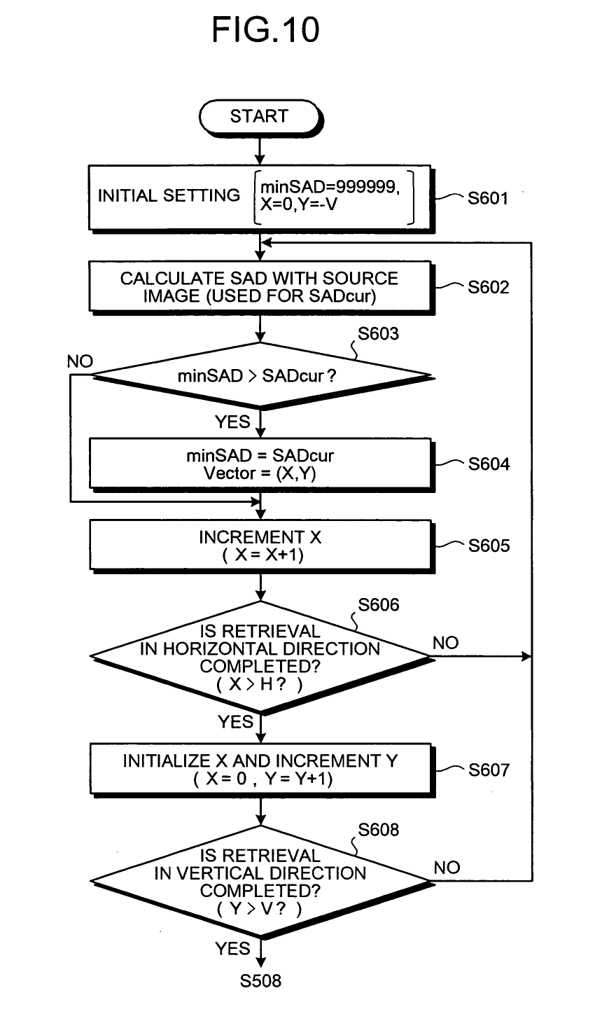

The full retrieving process in the calculation region (R) 410 is performed by the common circuit (R) using the image data read at step S502 (step S503). Specifically, under the control of the control unit (R) 311, the calculating unit (R) 313 refers to the image data stored temporarily in the cache memory (R) 312 to calculate the SAD that is image information of the source image and the calculation region. A minimum SAD (minSAD (R)) and the motion vector (Vector (R)) are calculated from the calculated SAD. Details of the full retrieving process at step S503 will be described later referring to FIG. 10.

In this specification, the smallest SAD is referred to as minSAD, and (R) or (L) of the common circuit is added to the minSAD calculated by different common circuits. The calculated motion vector will be referred to as the Vector, and (R) or (L) of the common circuit is added to the Vector calculated by different common circuits.

Specifically, the SAD and the minSAD calculated by the common circuit (R) are a SAD (R) and a minSAD (R), respectively, and the SAD and the minSAD calculated by the common circuit (L) are a SAD (L) and a minSAD (L), respectively. The Vector calculated by the common circuit (R) is Vector (R) and the Vector calculated by the common circuit (L) is Vector (L).

The common circuit (R) 310 outputs to the P-picture control unit 340 the minSAD (R) and the Vector (R) calculated in the full retrieving process at step S503 (step S504).

As is the case with steps S502 to S504, the common circuit (L) 320 reads the image data of the calculation region (L) 420 from the external memory 350 (step S505) and performs the full retrieving process in the calculation region (L) 420 (step S506). The common circuit (L) 320 outputs the minSAD (L) and the Vector (L) calculated in the full retrieving process at step S506 (step S507).

The P-picture control unit 340 compares the minSAD (R) and the minSAD (L) output at steps S504 and S507. For example, for the minSAD (R) and the minSAD (L) shown in FIG. 9, it is determined whether the minSAD (L) is smaller than the minSAD (R) or not (minSAD (L)<minSAD (R) ?) (step S58).

If the minSAD (L) is not smaller than the minSAD (R) at step S508 (step S508: NO), the minSAD is defined as the minSAD (R) and the Vector is defined as the Vector (R) (step S509) to terminate a series of processes. In other words, when the minSAD (L) is compared with the minSAD (R), if the minSAD (R) is smaller (or the same value), the smallest SAD is defined as the minSAD (R) and a vector corresponding to the minSAD (R) is defined as the motion vector.

If the minSAD (L) is smaller than the minSAD (R) at step S508 (step S508: YES), the minSAD is defined as the minSAD (L) and the Vector is defined as the Vector (L) (step S510) to terminate a series of processes.

As described above, the motion vector based on the smallest SAD can be calculated from the calculation region (R) 410 and the calculation region (L) 420 in the motion vector calculation process of FIG. 9. In other words, the movement of the source image can be predicted by using the SAD with the smallest amount of change from the source image to calculate the motion vector.

FIG. 10 is a flowchart of the full retrieving process (steps S503 to S506 in FIG. 9) by the motion vector calculation apparatus according to the first embodiment. Since the full retrieving processes are almost the same in the common circuit (R) 310 and the common circuit (L) 320, the full retrieving process in the common circuit (R) 310 will be described in the flowchart of FIG. 10.

Initial setting is performed by the control unit (R) 311 (step S601). The initial setting is, for example, the setting for the arbitrary calculation range (X, Y) and the minSAD in the calculation region (R) 410 and sets minSAD=999999, X=0, and Y=−V. For example, the minSAD may be a value that is sufficiently greater than the largest SAD. In the case of the full retrieving process in the common circuit (L) 320, the setting is minSAD=999999, and the initial setting is X=−H and Y=−V.

From the calculation region stored temporarily in the cache memory 312, the calculating unit (R) 313 calculates the SAD between the set calculation range (X, Y) and the source image (step S602) that are output to the control unit (R) 311. The SAD calculated at step S602 is defined as a SADcur, and the control unit (R) 311 determines whether the SADcur is smaller than the minSAD or not (minSAD>SADcur?) (step S603).

If the SADcur is not smaller than the minSAD at step S603 (step S603: NO), the control unit (R) 311 increments X (X=X+1) (step S605). Additionally, the control unit (R) 311 determines whether the retrieval in the horizontal direction is completed in the calculation region (R) 410 (X>H?) (step S606).

If the SADcur is smaller than the minSAD at step S603 (step S603: YES), the minSAD and the Vector are set to SADcur and (X, Y), respectively (step S604), and the procedure goes to step S605.

Specifically, if the calculated SADcur is smaller than the set minSAD, the minSAD is updated to a smaller value. The motion vector (X, Y) of the calculation range (X, Y) of the SADcur is calculated from the position (0, 0) of the calculation range when the motion vector of the source image is zero.

Specifically, at steps S605 and S606, it is determined for the calculation region (R) 410 whether the calculation region (R) 410 is exceeded by a calculation range (X, Y) shifted by one pixel to the right from the calculation range (X, Y) calculated at step S602.

When the common circuit (L) 320 performs steps S605 and S606, the control unit (L) 321 increments X (X=X+1) and determines whether the retrieval in the horizontal direction is completed in the calculation region (L) 420 (X>0?).

If the retrieval in the horizontal direction is not completed at step S606 (step S606: NO), the procedure goes back to step S602 to repeat the process. If the retrieval in the horizontal direction is completed at step S606 (step S606: YES), the control unit (R) 311 initializes X and increments Y (X=0, Y=Y+1) (step S607). Additionally, the control unit (R) 311 determines whether the retrieval in the vertical direction is completed in the calculation region (R) 410 (Y>V?) (step S608).

Specifically, at steps S607 and S608, it is determined for the calculation region (R) 410 whether the calculation region (R) 410 is exceeded by a calculation range (X, Y) shifted by one pixel downward from the calculation range (X, Y) calculated at the initial horizontal position. When the common circuit (L) 320 performs steps S607 and S608, the control unit (L) 321 initializes X, increments Y (X=0, Y=Y+1), and determines whether the retrieval in the vertical direction is completed in the calculation region (L) 420 (X>V+15?).

If the retrieval in the vertical direction is not completed at step S608 (step S608: NO), the procedure goes back to step S602 to repeat the process. If the retrieval in the vertical direction is completed at step S608 (step S608: YES), the minSAD and the Vector are defined as the minSAD (R) and the Vector (R); the full retrieving process at step S503 of FIG. 9 is terminated; and the procedure goes to step S508.

When the common circuit (L) 320 performs the full retrieving process, the minSAD and the Vector are defined as the minSAD (L) and the Vector (L); the full retrieving process at step S506 of FIG. 9 is terminated; and the procedure goes to step S508.

Thus, according to the first embodiment, since two common circuits can share the calculation region in the reference image to calculate the SAD, the SAD can be calculated from a wider calculation region to calculate an appropriate motion vector. Therefore, the accuracy of the P-picture is improved; the image quality is improved in the P-picture and the B-picture, which refers to the P-picture; and higher image quality can be achieved in the entire moving image.

Since the calculation for the P-picture is performed by using the common circuit used for generating the B-picture, the circuits can be used efficiently without installing a calculation circuit additionally.

Although the motion vector is calculated by using the full retrieving method illustrated in FIGS. 6A to 6F in the first embodiment described above, description will be made of the calculation of the motion vector using a track retrieving method in a second embodiment of the present invention.

In the track retrieving method, SAD is calculated in a calculation range (X, Y) as well as in a calculation range (X+1, Y), a calculation range (X−1, Y), a calculation range (X, Y+1), and a calculation range (X, Y−1), which are calculation ranges shifted by one pixel upward, downward, leftward, and rightward from the calculation range (X, Y), and the calculation range (X, Y) is replaced with a location of a smaller SAD.

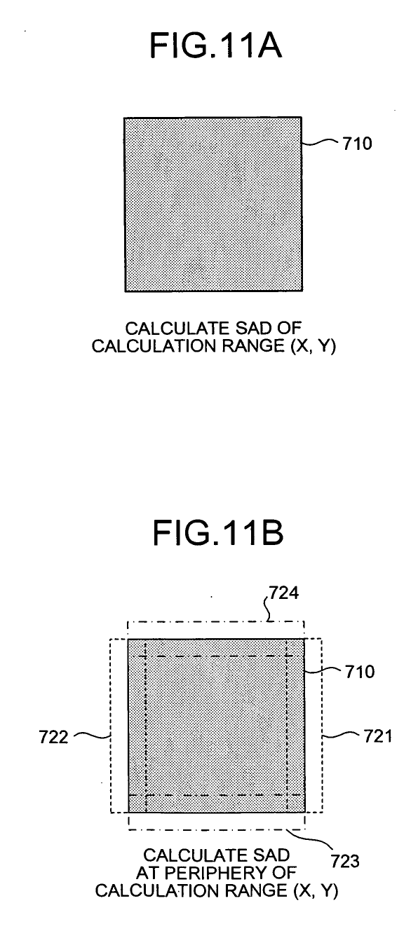

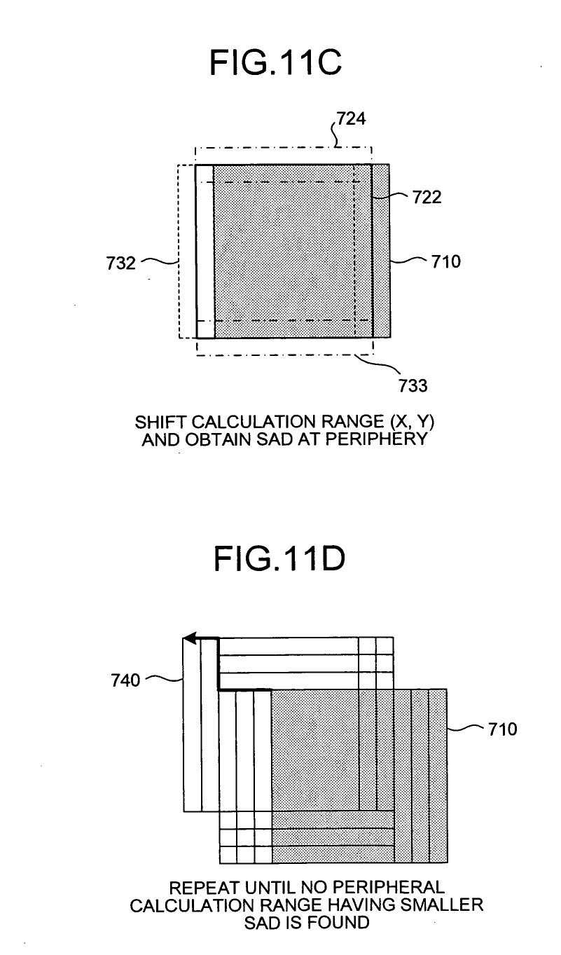

Similar processes are repeated until a location of a SAD smaller than the calculation range (X, Y) is not retrieved on the left, right, top and bottom of the calculation range (X, Y) to determined the motion vector. Details of the track retrieving method are described later referring to FIGS. 11A to 11D, and according to the track retrieving method, the number of times of the calculation can be reduced as compared to the full retrieving method, which retrieves the calculation range (X, Y) in the entire calculation region, as described above.

In the second embodiment, since two common circuits share calculations on the left, right, top, and bottom of the calculation range (X, Y) to perform the calculations with the use of the track retrieving method, about twofold calculations can be performed in the same processing time as compared to the conventional method and the tracking retrieval can be performed in a wider range. Since the process is performed without dividing the calculation region, the image data capacity read from the external memory 350 can be reduced as compared to the first embodiment, and power consumption and a circuit scale can be reduced.

Since the outline of the SAD calculation in the motion vector calculation apparatus according to the second embodiment is substantially the same as that shown in FIGS. 5A to 5F, and the motion vector calculation apparatus has substantially the same configuration as that shown in FIG. 7. Therefore, the description thereof is omitted.

FIG. 11A is a schematic for illustrating the track retrieving method according to the second embodiment. In the example shown in FIG. 11A, a calculation range (X, Y) 710 is a range for calculating the SAD for the source image and, for example, one arbitrary block in the reference image. The calculation range (X, Y) 710 may be determined by a past vector at the same position, a position when the motion vector of the source image is zero, etc. In the track retrieving method, the SAD is calculated between the calculation range (X, Y) 710 and the source image.

FIG. 11B is a schematic of the track retrieving method according to the second embodiment. As shown in FIG. 11B, a calculation range (X+1, Y) 721, a calculation range (X−1, Y) 722, a calculation range (X, Y+1) 723, and a calculation range (X, Y−1) 724 are located at the periphery of, i.e., on the right, left, bottom, and top of the calculation range (X, Y) 710, respectively.

In the track retrieving method, the SAD is calculated between the source image and each of the calculation range (X+1, Y) 721, the calculation range (X−1, Y) 722, the calculation range (X, Y+1) 723, and the calculation range (X, Y−1) 724.

The SAD of the calculation range (X, Y) 710 is compared with each SAD of the peripheral calculation range (X+1, Y) 721, the calculation range (X−1, Y) 722, the calculation range (X, Y+1) 723, and the calculation range (X, Y−1) 724 to retrieve a smaller SAD. In the description of FIGS. 11A to 11D, it is assumed that the SAD of the calculation range (X−1, Y) 722 is smallest.

FIG. 11C is a schematic of the track retrieving method according to the second embodiment. As shown in FIG. 11C, the calculation range (X, Y) 710, a calculation range (X−-2, Y) 732, a calculation range (X−1, Y+1) 733, and a calculation range (X−1, Y−1) 734 are located at the periphery of, i.e., on the right, left, bottom, and top of the calculation range (X−1, Y) 722 having the smallest SAD in FIG. 11C. As is the case with FIG. 11B, the SAD is calculated in each of the calculation range (X, Y) 710, calculation range (X−2, Y) 732, calculation range (X−1, Y+1) 733, and calculation range (X−1, Y−1) 734 to retrieve a smaller SAD.

FIG. 11D is a schematic of the track retrieving method according to the second embodiment. In FIG. 11D, the calculation range (X−5, Y−3) 740 is a position where a smaller SAD cannot be retrieved at the periphery thereof after repeating the processes shown in FIGS. 11A to 11C. In the track retrieving method, the motion vector is determined by performing the process as described in FIGS. 11A to 11D.

Specifically, the calculation range (X, Y) is set to a calculation range (0, 0), which is a position when the motion vector of the source image is zero. If the track retrieving method of FIGS. 11A to 11D is performed, a smaller SAD cannot be retrieved at the periphery of a calculation range (−5, −3) and, therefore, the motion vector of the source image is (−5, −3).

Although the calculation of the SAD in the description of FIGS. 11A to 11D is performed at the periphery of the calculation range (X, Y) 710, which is limited to the left, right, top and bottom thereof, the periphery may include the upper right (left) and the lower right (left) of the calculation range (X, Y) 710 and is one macroblock included within a predetermined range from the calculation range (X, Y) 710.

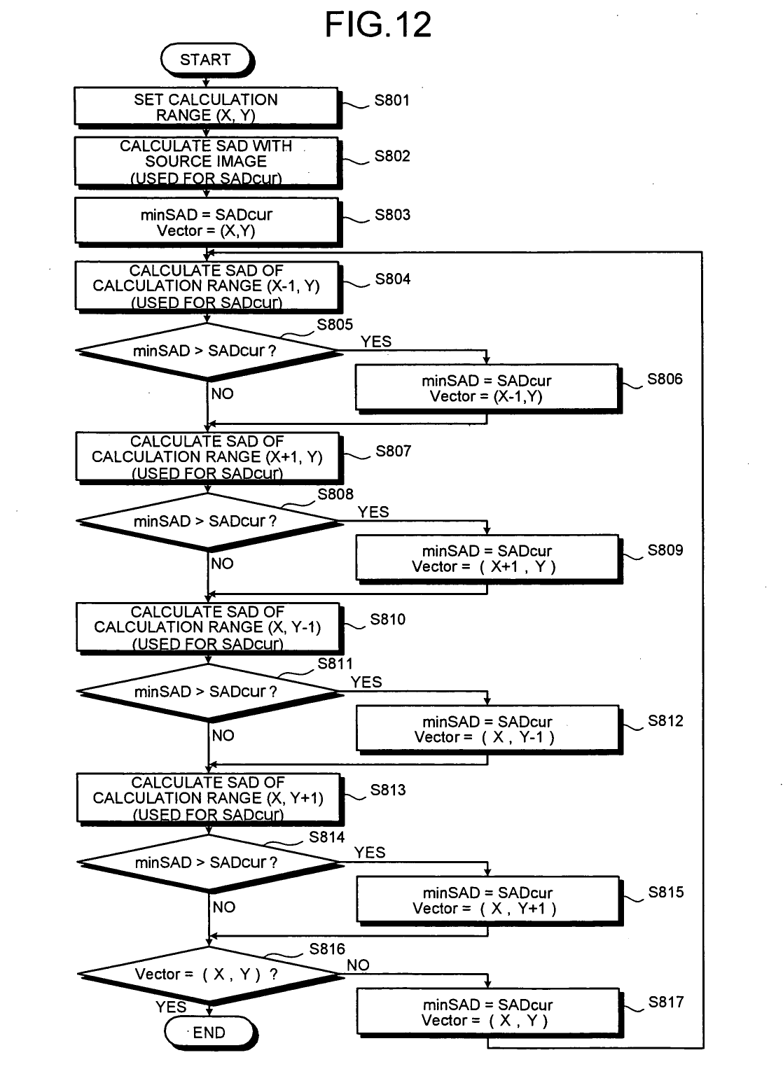

FIG. 12 is a flowchart of a process of the track retrieving method shown in FIGS. 11A to 11D.

In the flowchart of FIG. 12, the motion vector calculation apparatus 300 sets an arbitrary calculation range (X, Y) in the reference image (step S801). The SAD is calculated between the calculation range (X, Y) set at step S810 and the SAD of the source image (step S802), and this SAD is defined as the SADcur. In the description of FIG. 12, a calculation range (0, 0) is the calculation range when the motion vector of the source image is zero.

The motion vector calculation apparatus 300 sets minSAD=SADcur and Vector=(X, Y) from the calculation range (X, Y) set at step S810 and the SADcur calculated at step S802 (step S803).

The minSAD is the smallest SAD at each stage of the process of the track retrieving method and the Vector is a motion vector at each stage of the process of the track retrieving method. In other words, the motion vector generating the smallest SAD for the source image can be determined from the minSAD and the Vector at the last stage of the process of the track retrieving method.

The motion vector calculation apparatus 300 calculates a SAD of a calculation range (X−1, Y) shifted by one pixel to the left from the calculation range (X, Y) to define the SAD as the SADcur (step S804) and determines whether the SADcur is smaller than the minSAD or not (minSAD>SADcur?) (step S805).

If the SADcur is not smaller than the minSAD at step S805 (step S805: NO), a SAD is calculated for a calculation range (X−1, Y) shifted by one pixel to the right from the calculation range (X, Y) and is defined as the SADcur (step S807), and it is determined whether the SADcur is smaller than the minSAD (minSAD>SADcur?) (step S808).

If the SADcur is smaller than the minSAD at step S805 (step S805: YES), the minSAD and the Vector are set to the SADcur and (X−1, Y), respectively (step S806), and the procedure goes to step S807.

Specifically, if the calculated SADcur is smaller than the set minSAD, the minSAD is updated to a smaller value. The vector is set correspondingly to a smaller minSAD.

If the SADcur is not smaller than the minSAD at step S808 (step S808: NO), a SAD is calculated for a calculation range (X, Y−1) shifted by one pixel upward from the calculation range (X, Y) and is defined as the SADcur (step S810), and it is determined whether the SADcur is smaller than the minSAD (minSAD>SADcur?) (step S811).

If the SADcur is smaller than the minSAD at step S808 (step S808: YES), the minSAD and the Vector are set to the SADcur and (X−1, Y), respectively (step S809), and the procedure goes to step S810.

If the SADcur is not smaller than the minSAD at step S811 (step S811: NO), a SAD is calculated for a calculation range (X, Y+1) shifted by one pixel downward from the calculation range (X, Y) and is defined as the SADcur (step S813), and it is determined whether the SADcur is smaller than the minSAD or not (minSAD>SADcur?) (step S814).

If the SADcur is smaller than the minSAD at step S811 (step S811: YES), the minSAD and the Vector are set to the SADcur and (X, Y−1), respectively (step S812), and the procedure goes to step S813.

If the SADcur is not smaller than the minSAD at step S814 (step S814: NO), it is determined whether the Vector is (X, Y) or not (step S816).

Specifically, it is determined whether a motion vector other than (X, Y) is set because the SAD calculated at steps S804, S807, S810, and S813 is smaller than the minSAD.

If the SADcur is smaller than the minSAD at step S814 (step S814: YES), the minSAD and the Vector are set to the SADcur and (X, Y+1), respectively (step S815), and the procedure goes to step S816.

If the Vector is (X, Y) at step S816 (step S816: YES), a series of processes is simply terminated. In other words, since the SAD calculated at steps S804, S807, S810, and S813 is larger than the minSAD, the motion vector (X, Y) generating the smallest SAD for the source image can be determined.

In the second embodiment, the common circuit (R) 310 and the common circuit (L) 320 of the motion vector calculation apparatus 300 share and perform the SAD calculations of the track retrieving method.

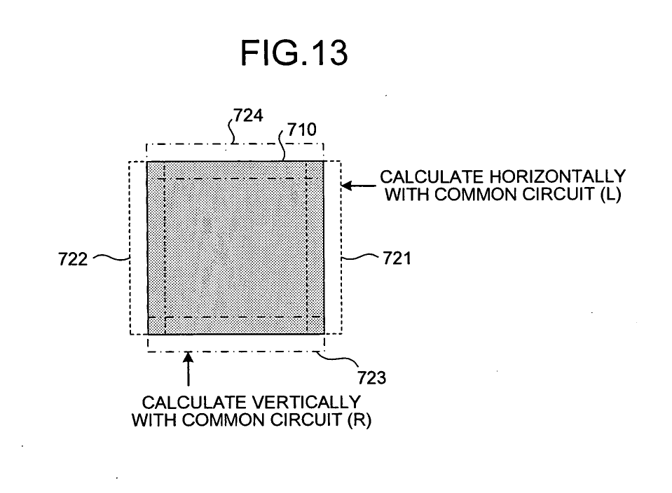

FIG. 13 is an explanatory diagram of the SAD calculations of the track retrieving method in the motion vector calculation apparatus according to the second embodiment of the present invention. The calculation range (X, Y) described in FIGS. 11A to 11D is used in the description of FIG. 13.

In FIG. 13, the calculation range (X+1, Y) 721, the calculation range (X−1, Y) 722, the calculation range (X, Y+1) 723, and the calculation range (X, Y−1) 724 are located at the periphery of, i.e., on the right, left, bottom, and top of an arbitrary calculation range (X, Y) 710 in the reference image, respectively. In the motion vector calculation apparatus 300 of the second embodiment, the common circuit (R) 310 and the common circuit (L) 320 calculate the SAD of the top calculation range (X, Y+1) 723 and the bottom calculation range (X, Y−1) 724 as well as the SAD of the right calculation range (X+1, Y) 721 and the left calculation range (X−1, Y) 722 in a separated manner in the track retrieving method.

In other words, in the same calculation region, the calculation range (X, Y+1) 723 and the calculation range (X, Y−1) 724 on the bottom and top of the calculation range (X, Y) 710 are defined as a first calculation region; the calculation range (X+1, Y) 721 and the calculation range (X−1, Y) 722 on the right and left of the calculation range (X, Y) 710 are defined as a second calculation region; and the common circuit (R) 310 and the common circuit (L) 320 performs the calculations in a separated manner.

Specifically, the common circuit (R) 310 calculates the SAD of the top calculation range (X, Y+1) 723 and the bottom calculation range (X, Y−1) 724, and the common circuit (L) 320 calculates the SAD of the right calculation range (X+1, Y) 721 and the left calculation range (X−1, Y) 722.

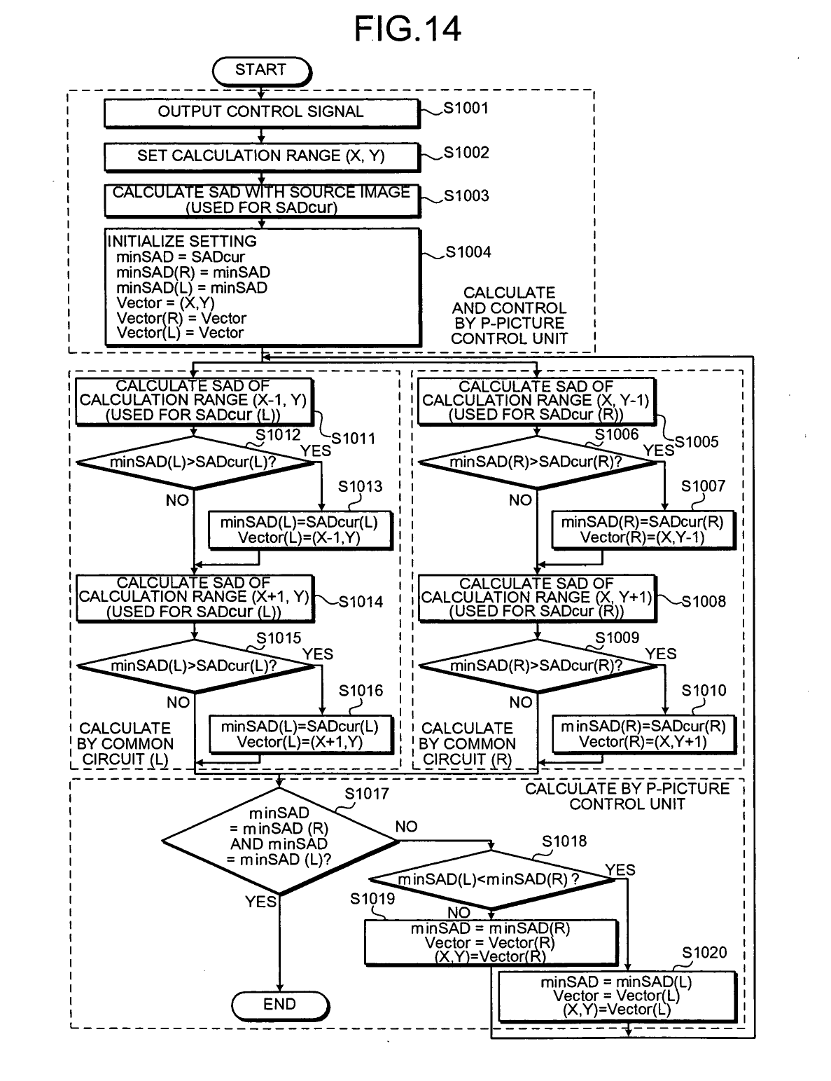

While details of-the process of the track retrieving method in the motion vector calculation apparatus 300 according to the second embodiment will be described later in FIG. 14, since the tracking retrieval is shared by the common circuit (R) 310 and the common circuit (L) 320, the SAD at the periphery of the calculation range (X, Y) can be calculated in a half of the conventional time. Therefore, the processing time can be reduced.

FIG. 14 is a flowchart of a motion vector calculation process by the motion vector calculation apparatus according to the second embodiment. In the motion vector calculation apparatus 300 according to the second embodiment, a motion vector is calculated by using the track retrieving method illustrated in FIG. 13.

In the flowchart of FIG. 14, the P-picture control unit 340 outputs control signals to the common circuit (R) 310 and the common circuit (L) 320 (step S1001). The control signals are, for example, signals that request the control unit (R) 311 and the control unit (L) 321 to read from the external memory 350 the image data of the calculation region for calculating the SAD of the reference image in the temporally forward direction from the source image and to write the image data into the cache memory (R) 312 and the cache memory (L) 322.

In accordance with the control signal input at step S1001, the P-picture control unit 340 sets an arbitrary calculation range (X, Y) from the image data of the calculation region stored temporarily in the cache memory (R) 312 and the cache memory (L) 322 (step S1002).

The P-picture control unit 340 calculates the SAD between the calculation range (X, Y) set at step S1002 and the source image (step S1003) and this SAD is defined as the SADcur. In the description of FIG. 14, a calculation range (0, 0) is the calculation range when the motion vector of the source image is zero.

The P-picture control unit 340 initializes the setting of the motion vector calculation process in the flowchart of FIG. 14 (step S1004). In the initialization of the setting, (R) and (L) are added to parameters used by the common circuit (R) 310 and the common circuit (L) 320, respectively.

Specifically, the SADcur calculated at step S1003 is used to set minSAD=SADcur, minSAD (R)=minSAD, and minSAD (L)=minSAD. Vector=(X, Y), Vector (R)=Vector, and Vector (L)=Vector are also set. The minSAD is the smallest SAD at each stage of the process of the track retrieving method and the Vector is a motion vector at each stage of the process of the track retrieving method.

The common circuit (R) 310 calculates a SAD of a calculation range (X, Y−1) shifted by one pixel upward from the calculation range (X, Y) to define the SAD as the SADcur (R) (step S1005) and determines whether the SADcur (R) is smaller than the minSAD (R) or not (minSAD (R)>SADcur (R)?) (step S1006).

If the SADcur (R) is not smaller than the minSAD (R) at step S1006 (step S1006: NO), a SAD is calculated for a calculation range (X, Y+1) shifted by one pixel upward from the calculation range (X, Y) and is defined as the SADcur (R) (step S1008), and it is determined whether the SADcur (R) is smaller than the minSAD (R) or not (minSAD (R)>SADcur (R)?) (step S1009).

If the SADcur (R) is smaller than the minSAD (R) at step S1006 (step S1006: YES), the minSAD (R) and the Vector (R) are set to the SADcur (R) and (X, Y−1), respectively (step S1007), and the procedure goes to step S1008.

Specifically, if the calculated SADcur (R) is smaller than the set minSAD (R), the minSAD (R) is updated to a smaller value. The vector (R) is set correspondingly to a smaller minSAD (R).

If the SADcur (R) is not smaller than the minSAD (R) at step S1009 (step S1009: NO), the process proceeds to step S1017.

If the SADcur (R) is smaller than the minSAD (R) at step S1009 (step S1009: YES), the minSAD (R) and the Vector (R) are set to the SADcur (R) and (X, Y+1), respectively (step S1010), and the procedure goes to step S1017.

The common circuit (L) 320 calculates a SAD of a calculation range (X−1, Y) shifted by one pixel to the left from the calculation range (X, Y) to define the SAD as the SADcur (L) (step S1011) and determines whether the SADcur (L) is smaller than the minSAD (L) (minSAD (L)>SADcur (L)?) (step S1012).

If the SADcur (L) is not smaller than the minSAD (L) at step S1012 (step S1012: NO), a SAD is calculated for a calculation range (X+1, Y) shifted by one pixel to the right from the calculation range (X, Y) and is defined as the SADcur (L) (step S1014), and it is determined whether the SADcur (L) is smaller than the minSAD (L) (minSAD (L)>SADcur (L)?) (step S1015).

If the SADcur (L) is smaller than the minSAD (L) at step S1012 (step S1012: YES), the minSAD (L) and the Vector (L) are set to the SADcur (L) and (X−1, Y), respectively (step S1013), and the procedure goes to step S1014.

If the SADcur (L) is not smaller than the minSAD (L) at step S1015 (step S1015: NO), the procedure goes to step S1017. If the SADcur (L) is smaller than the minSAD (L) at step S1015 (step S1015: YES), the minSAD (L) and the Vector (L) are set to the SADcur (L) and (X+1, Y), respectively (step S1016), and the procedure goes to step S1017.

From the minSAD, minSAD (R), and minSAD (L) calculated in the process from steps S1004 to S1016, it is determined whether minSAD=minSAD (R) and minSAD=minSAD (L) are established (step S1017). In other words, it is determined whether the minSAD (R) and minSAD (L) calculated by the common circuit (R) 310 and the common circuit (L) 320 become the smallest.

If minSAD-minSAD (R) and minSAD=minSAD (L) are established at step S1017 (step S1017: YES), a series of processes are simply terminated. The Vector at the time of the termination of the process is the motion vector generating the smallest SAD for the source image.

If minSAD=minSAD (R) and minSAD=minSAD (L) are not established at step S1017 (step S1017: NO), it is determined whether the minSAD (L) is smaller than the minSAD (R) (step S1018).

If the minSAD (L) is not smaller than the minSAD (R) at step S1018 (step S1018: NO), the parameters in the common circuit (R) 310 is reset (step S1019), and the procedure goes back to steps S1005 and S1011 to repeat the process. Specifically, the resetting of the process is minSAD-minSAD (R), Vector=Vector (R), and (X, Y)=Vector (R).

If the minSAD (L) is smaller than the minSAD (R) at step S1018 (step S1018: YES), the parameters in the common circuit (L) 310 is reset (step S1020), and the procedure goes back to steps S1005 and S1011 to repeat the process. Specifically, the resetting of the process is minSAD=minSAD (L), Vector=Vector (L), and (X, Y)=Vector (L).

In this way, according to the second embodiment, the smallest SAD can be retrieved in the track retrieving method without calculating the SAD in the entire calculation region. Therefore, the processing time for the motion vector calculation can be reduced to acquire an appropriate P-picture.

By acquiring an appropriate P-picture, the image quality is improved in the P-picture and the B-picture, which refers to the P-picture, and higher image quality can be achieved in the entire moving image. Since the SAD calculation can be shared by two common circuits also in the track retrieving method, the reduction of the circuit scale can be achieved.

In the first and the second embodiments described above, the SAD calculation has been performed by using two cache memories, i.e., the cache memory (R) 312 and the cache memory (L) 322. In a third embodiment of the present invention, description will be made of the case that the motion vector of the source image is calculated by one cache memory that temporarily stores the image data of the calculation region for calculating the SAD. By performing the process with one cache memory, the power consumption of the cache memory is reduced. Since the SAD calculation in a motion vector calculation according to the third embodiment is substantially the same as that shown in FIGS. 5A and 5B and the full retrieving method is substantially the same as that shown in FIGS. 6A to 6F, the description thereof is omitted.

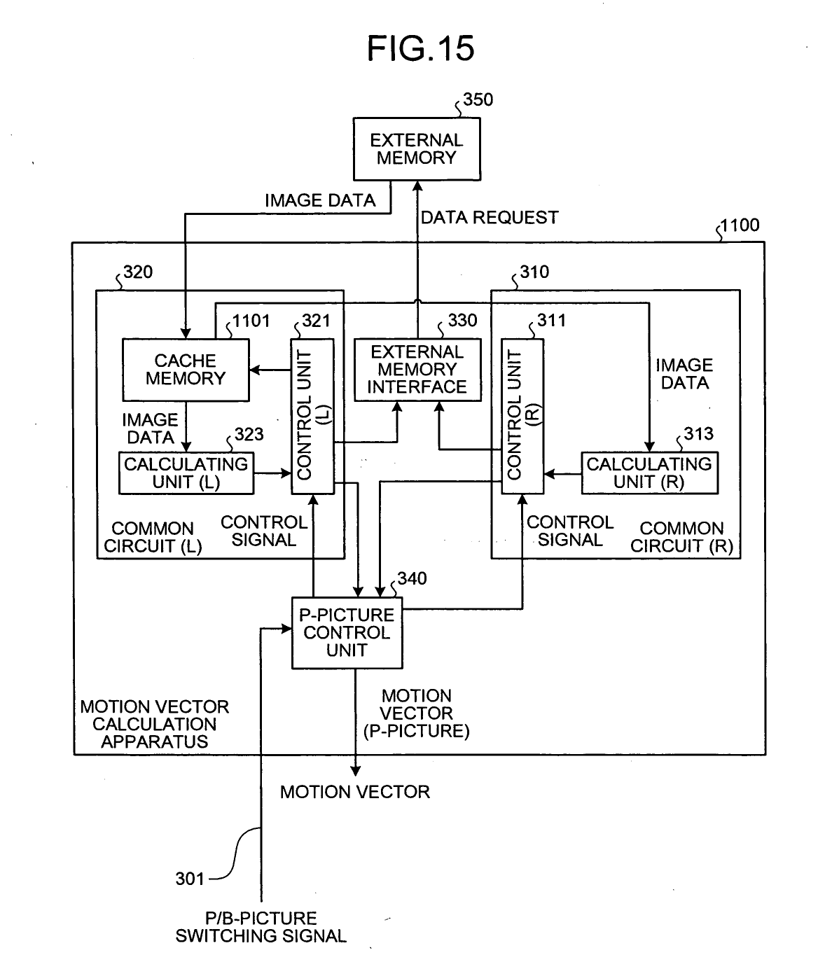

FIG. 15 is a schematic of a motion vector calculation apparatus according to the third embodiment. The same reference characters as in FIG. 7 are added to the components that are similar to that shown in FIG. 7, and the description thereof is omitted.

A motion vector calculation apparatus 1100 includes the common circuit (R) 310, the common circuit (L) 320, the external memory interface 330, and the P-picture control unit 340. The common circuit (R) 310 includes the control unit (R) 311 and the calculating unit (R) 313. The common circuit (L) 320 is constituted by the control unit (L) 321, a cache memory 1101, and the calculating unit (L) 323.

The cache memory 1101 temporarily stores the image data of the calculation region in the reference image input from the external memory 350. The image data stored temporarily are output to the calculating unit (R) 313 and the calculating unit (L) 323 under the control of the control unit (L) 321.

Although the cache memory 1101 is included in the common circuit (L) 320 in the description of FIG. 15, the cache memory 1101 may be included in the common circuit (R) 310. The function of the cache memory 1101 may be achieved by the cache memory (R) 312 or the cache memory (L) 322 described above in FIG. 7.

In the output of the image data, with regard to an arbitrary calculation range (X, Y) of the calculation region in the reference image, the image data are output to the calculating unit (R) 313 and the calculating unit (L) 323 such that the calculating unit (R) 313 and the calculating unit (L) 323 calculate the SAD of odd number rows and even number rows of the calculation range (X, Y) in a separated manner.

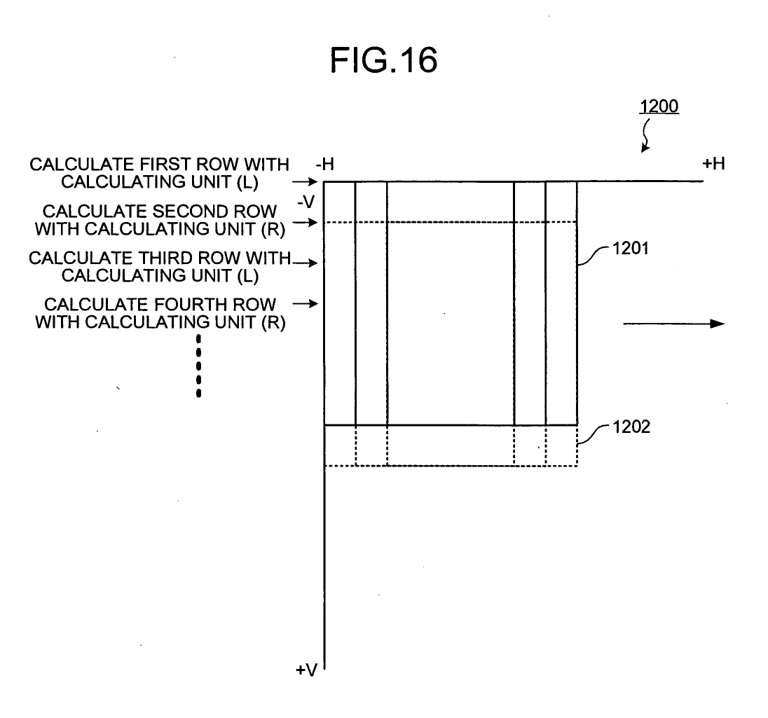

FIG. 16 is a schematic of the calculation region for calculating the SAD corresponding to the source image according to the third embodiment. In FIG. 16, a calculation region 1200 is constituted by a calculation range group 1201 at a first row and a calculation range group 1202 at a second row.

Specifically, in the calculation region 1200, when the horizontal direction is from −H to H and the vertical direction is from −V to V, the calculation range group 1201 is a calculation range (−H, −V), a calculation range (−H+1, −V), a calculation range (−H+2, −V), etc. The calculation range group 1202 is a calculation range (−H, −V+1), a calculation range (−H+1, −V+1), a calculation range (−H+2, −V+1), etc. Although not shown, calculation range groups at third and fourth rows can also be represented.

Referring to FIG. 15 again, the cache memory 1101 outputs the calculation range group 1201 and the calculation range group 1202 to the calculating unit (L) 323 and the calculating unit (R) 313, respectively, under the control of the control unit (L) 321. The calculating unit (L) 323 and the calculating unit (R) 313 refer to the calculation range groups 1201 and 1202, respectively, to calculate the SAD.

In other words, the calculating unit (R) 313 and the calculating unit (L) 323 read from the cache memory 1101 the image data of 16 pixels×17 rows in the same calculation region 1200 and calculate the SAD of one upper macroblock, i.e., a first calculation region and one lower macroblock, i.e., a second calculation region respectively in a separated manner. The motion vector can be calculated by calculating the SAD in the calculation region 1200 with the use of the full retrieving method described above in FIGS. 6A to 6F.

If the calculation region 1200 is odd-numbered in the vertical direction, the calculating unit (L) 323 may perform the calculation for the last calculation range group, i.e., a calculation range (−H, V), a calculation range (−H+1, V), a calculation range (−H+2, V), . . . , and a calculation range (H, V) while the calculating unit (R) 313 is not operated.

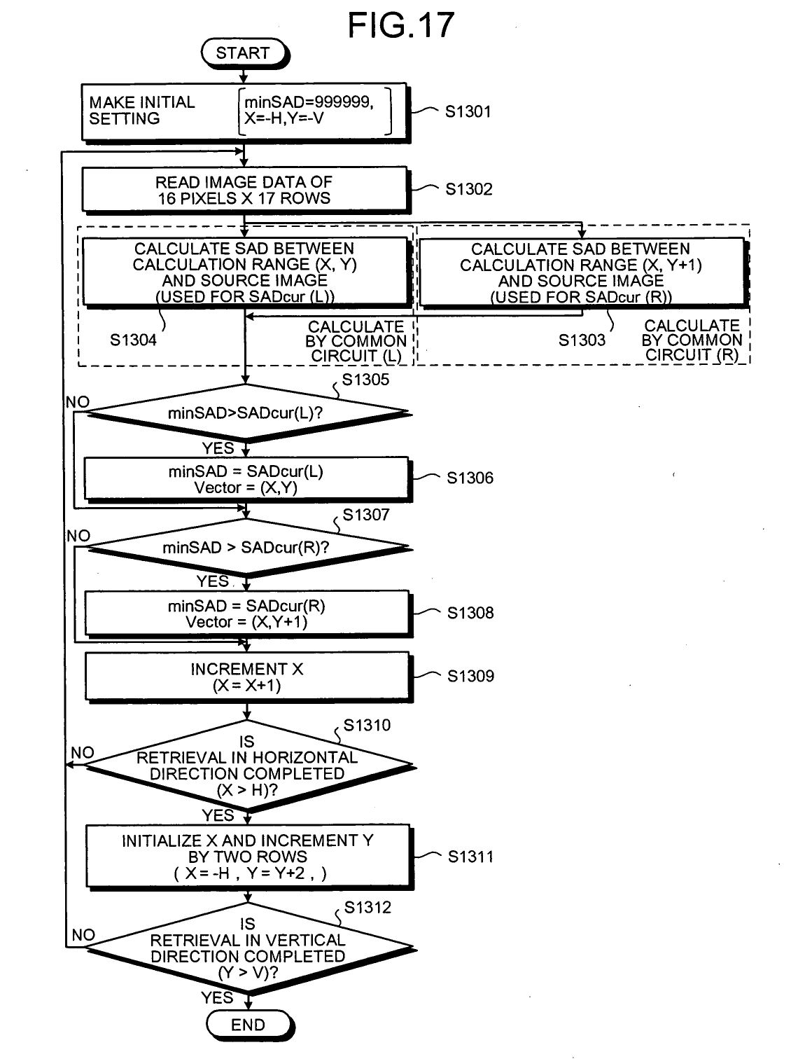

FIG. 17 is a flowchart of a motion vector calculation process by the motion vector calculation apparatus according to the third embodiment. In the motion vector calculation apparatus 100 according to the third embodiment, description will be made of a process of sharing the calculation for the calculation range groups between the common circuit (R) 310 and the common circuit (L) 320 with the use of the cache memory 1101 described above.

Initial setting is performed by the control unit (R) 311 and the control unit (L) 321 (step S1301). The initial setting is, for example, the setting for the arbitrary calculation range (X, Y) and the minSAD in the calculation region 1200 and sets minSAD=999999, X=−H, and Y=−V. For example, the minSAD may be a value that is sufficiently greater than the largest SAD. In the case of the full retrieving process in the common circuit (L) 320, the setting is minSAD=999999, and the initial setting is X=−H and Y=−V.

Under the control of the control unit (L) 321, the calculating unit (R) 313 and the calculating unit (L) 323 read from the cache memory 1101 the image data of 16 pixels×17 rows (step S1302). In the reading of the image data, among the image data of 16 pixels×17 rows, a calculation range (X, Y), i.e., the upper macroblock is read by the calculating unit (L) 323, and a calculation range (X, Y+1), i.e., the lower macroblock is read by the calculating unit (R) 313.

The calculating unit (R) 313 calculates the SAD between the calculation range (X, Y+1) read from the cache memory 1101 and the source image (step S1303), and the calculated SAD is defined as a SADcur (R) and is output to the control unit (R) 311. Similarly, the calculating unit (L) 323 calculates the SAD between the calculation range (X, Y) read from the cache memory 1101 and the source image (step S1304), and the calculated SAD is defined as a SADcur (L) and is output to the control unit (L) 321.

The control unit (L) 321 determines whether the SADcur (L) calculated at step S1304 is smaller than the minSAD or not (minSAD>SADcur (L)?) (step S1305).

If the SADcur (L) is not smaller than the minSAD at step S1305 (step S1305: NO), the procedure goes to step S1307, and the control unit (R) 311 determines whether the SADcur (R) calculated at step S1303 is smaller than the minSAD or not (minSAD>SADcur (R)?) (step S1307).

If the SADcur (L) is smaller than the minSAD at step S1305 (step S1305: YES), the minSAD and the Vector are set to SADcur (L) and (X, Y), respectively (step S1306), and the procedure goes to step S1307.

Specifically, if the calculated SADcur (L) is smaller than the set minSAD, the minSAD is updated to a smaller value. The motion vector (X, Y) of the calculation range (X, Y) of the SADcur (L) is calculated from the position (0, 0) of the calculation range when the motion vector of the source image is zero.

If the SADcur (R) is not smaller than the minSAD at step S1307 (step S1307: NO), the control unit (R) 311 or the control unit (L) 321 increments X (X=X+1) (step S1309). Additionally, the control unit (R) 311 and the control unit (L) 321 determine whether the retrieval in the horizontal direction is completed in the calculation region 1200 (X>H?) (step S1310).

If the SADcur (R) is smaller than the minSAD at step S1307 (step S1307: YES), the minSAD and the Vector are set to SADcur and (X, Y+1), respectively (step S1308), and the procedure goes to step S1309.

If the retrieval in the horizontal direction is not completed at step S1310 (step S1310: NO), the procedure goes back to step S1302 to repeat the process. If the retrieval in the horizontal direction is completed at step S1310 (step S1310: YES), the control unit (R) 311 and the control unit (L) 321 initialize X and increments Y by two rows (X=0, Y=Y+2) (step S1311). Additionally, the control unit (R) 311 and the control unit (L) 321 determine whether the retrieval in the vertical direction is completed in the calculation region 1200 (Y>V?) (step S1312).

If the retrieval in the vertical direction is not completed at step S1312 (step S1312: NO), the procedure goes back to step S1302 to repeat the process. If the retrieval in the vertical direction is completed at step S1312 (step S1312: YES), a series of the processes is simply terminated. The Vector at the time of the termination of the process is the motion vector generating the smallest SAD for the source image.

Thus, according to the third embodiment, since the process is performed by one cache memory when the SAD is calculated by sharing the calculation region in the reference image between two common circuits, the power consumption of the circuit can be reduced.

In the first, the second, and the third embodiments described above, the SAD calculation has been performed by using two calculating units, i.e., the calculating unit (R) 313 and the calculating unit (L) 323. In the fourth embodiment, description will be made of the case that one calculating unit calculates the SAD for the right calculating region (R) 410 and the left calculation region (L) 420 in the calculation region 400 described above in the first embodiment.

Since the SAD is calculated from a plurality of calculation regions in the configuration of the fourth embodiment, the retrieval range can be wider than the conventional range.

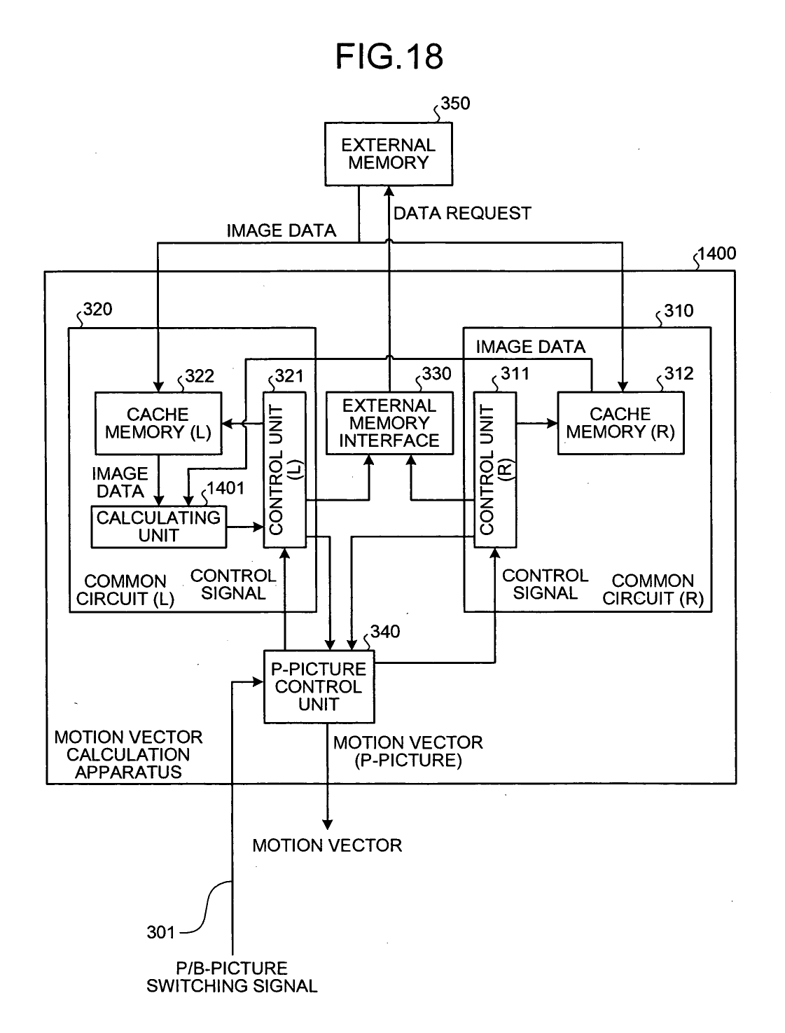

FIG. 18 is a schematic of the motion vector calculation apparatus according to the fourth embodiment of the present invention. The same reference characters as in FIG. 7 are added to the components that are substantially the same as that of FIG. 7, and the description thereof is omitted.

As shown in FIG. 18, a motion vector calculation apparatus 1400 includes the common circuit (R) 310, the common circuit (L) 320, the external memory interface 330, and the P-picture control unit 340. The common circuit (R) 310 includes the control unit (R) 311 and a cache memory (R) 312. The common circuit (L) 320 includes by the control unit (L) 321, a cache memory 1322, and a calculating unit 1401.

The calculating unit 1401 refers to the image data of the compression target source image and the image data of the calculation region stored in the cache memory (R) 312 and the cache memory (L) 322 to calculate the SAD, which is image information of the source image and the calculation region. The calculating unit 1401 outputs the calculated SAD to the control unit (L) 321.

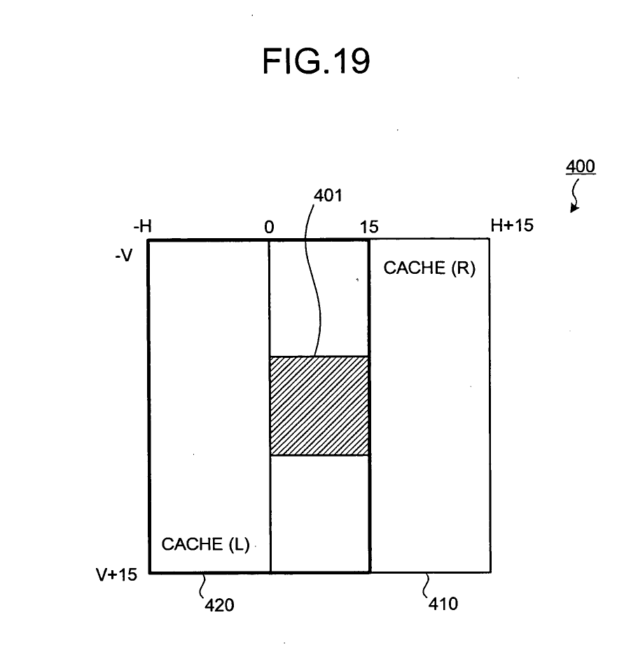

FIG. 19 is a schematic of the calculation region for calculating the SAD corresponding to the source image according to the fourth embodiment. Since the calculation region according to the fourth embodiment has the same configuration as in FIG. 8, the same reference characters are added. The calculation region 400 includes the right calculation region (R) 410 and the left calculation region (L) 420.

The control unit (R) 311 and the control unit (L) 321 perform acquisition requests for the image data of the calculation region (R) 410 and the calculation region (L) 420, and the image data are input to the calculating unit 1401. In this way, the SAD calculation region becomes wider and the motion vector can be calculated more accurately.

Although the calculating unit 1401 is included in the common circuit (L) 320 in the description of FIG. 18, the calculating unit 1401 may be included in the common circuit (R) 310. The function of the calculating unit 1401 may be achieved by the calculating unit (R) 313 or the calculating unit (L) 323 described above in FIG. 7. The procedure of the motion vector calculation process may be performed with the use of the full retrieving method or the track retrieving method.

Thus, according to the fourth embodiment, since the process is performed by one calculating unit when the SAD is calculated by sharing the calculation region in the reference image between two common circuits, the power consumption of the circuit can be reduced. Since the SAD can be calculated with the calculation region divided, the SAD can be calculated from a wider calculation region and an appropriate motion vector can be calculated to achieve higher image quality in the entire moving image.

In the first, the second, the third, and the fourth embodiments described above, the SAD calculation has been performed by using two common circuits, i.e., the common circuit (R) 310 and the common circuit (L) 320. In the fifth embodiment, the SAD is calculated by providing three common circuits. By utilizing more common circuits, the retrieval range can be expanded and the processing ability can be enhanced to acquire higher quality images. Although three common circuits are described in the fifth embodiment, the same applies to the case of using four or more common circuits.

Since the SAD calculation in the motion vector calculation according to the fifth embodiment is substantially the same as shown FIGS. 5A and 5B and the full retrieving method is substantially the same as FIGS. 6A to 6F, the description thereof is omitted.

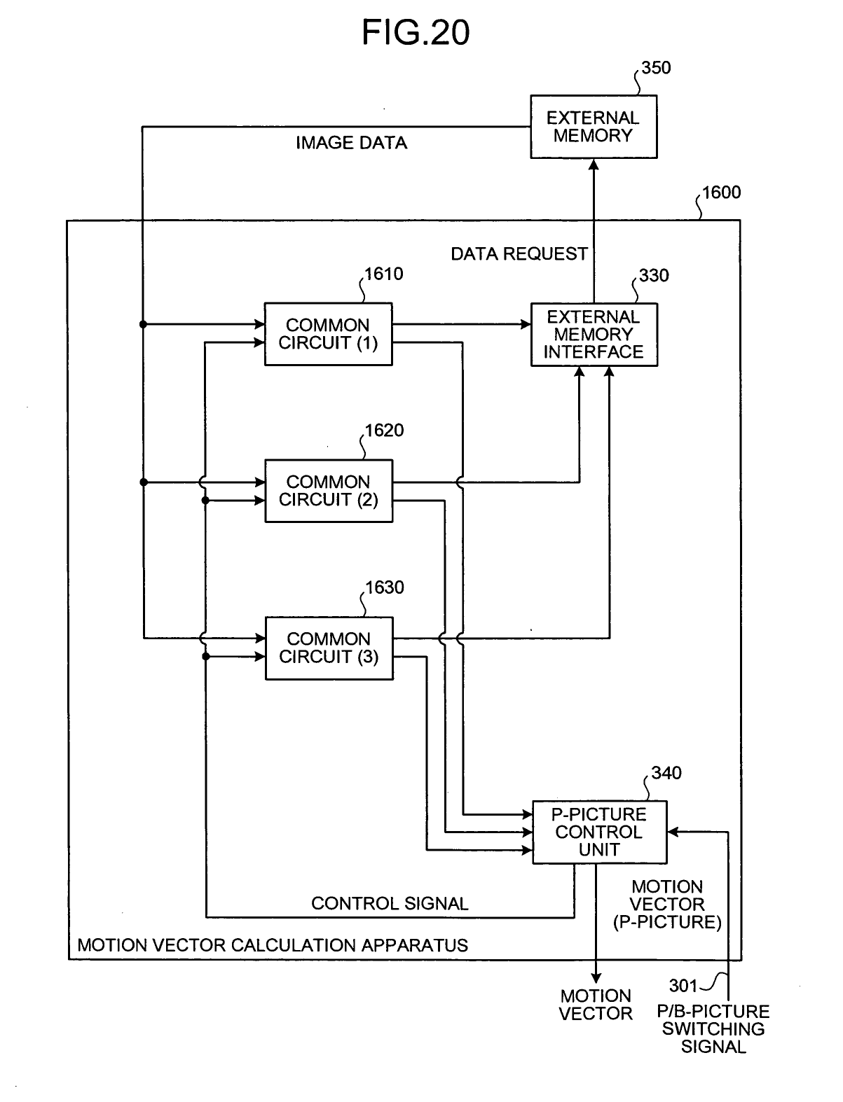

FIG. 20 is a schematic of the motion vector calculation apparatus according to the fifth embodiment. In FIG. 20, the same reference characters as in FIG. 7 are added to the components that are substantially the same as that of FIG. 7, and the description thereof is omitted.

As shown in FIG. 20, a motion vector calculation apparatus 1600 includes a common circuit (1) 1610, a common circuit (2) 1620, a common circuit (3) 1630, the external memory interface 330, and the P-picture control unit 340.

Although not shown, each of the common circuit (1) 1610, the common circuit (2) 1620, and the common circuit (3) 1630 includes a control unit, a cache memory, and a calculating unit, and the function is substantially the same as the common circuit (R) 310 and the common circuit (L) 320 illustrated in FIG. 7 and will not be described.

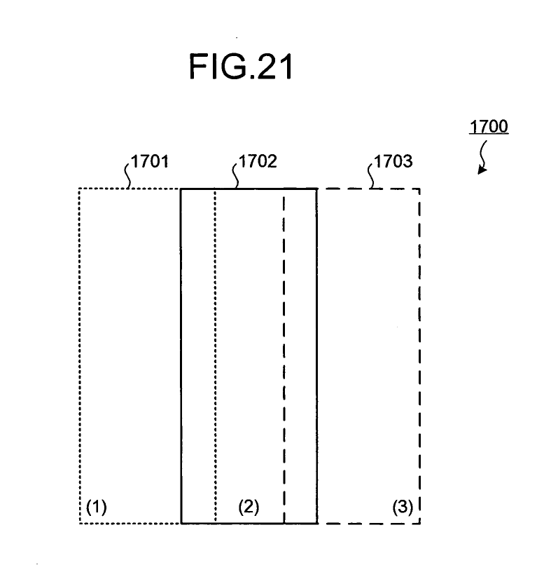

FIG. 21 is a schematic the calculation region for calculating the SAD corresponding to the source image according to the fifth embodiment of the present invention. In FIG. 21, a calculation region 1700 is constituted by a right calculation region (1) 1701, a middle calculation region (2) 1702, and a left calculation region (3) 1703.

As is the case with FIG. 8 described above, the calculation region 1700 is a region included in the reference image in the temporally forward direction from the source image, and each of the calculation region (1) 1701, the calculation region (2) 1702, and the calculation region (3) 1703 includes a calculation range when the motion vector of the source image is zero.

Referring to FIG. 20 again, each of the common circuit (1) 1610, the common circuit (2) 1620, and the common circuit (3) 1630 uses the control unit not shown to output an acquisition request for the image data of each calculation region to the external memory interface 330.

Specifically, the common circuit (1) 1610 performs the acquisition request for the image data of the calculation region (1) 1701 illustrated in FIG. 21. The common circuit (2) 1620 performs the acquisition request for the image data of the calculation region (2) 1702 illustrated in FIG. 21. Similarly, the common circuit (3) 1630 performs the acquisition request for the image data of the calculation region (3) 1703 illustrated in FIG. 21.

In the common circuit (1) 1610, the common circuit (2) 1620, and the common circuit (3) 1630, the calculating units not shown calculate the SAD of all the calculation ranges (X, Y) within the calculation range 1700 by the full retrieving method illustrated in FIG. 6A to 6F. The calculated SAD is output to the P-picture control unit 340, and the P-picture control unit 340 calculates the motion vector for generating the P-picture of the source image and outputs the motion vector to an external apparatus not shown. Specifically, by comparing the calculation results input from the calculating units not shown in the common circuit (1) 1610, the common circuit (2) 1620, and the common circuit (3) 1630, the destination of the source image is identified in the forward frame image that is defined as the reference image to calculate the motion vector of the source image.

Thus, since the calculation region 1700 is divided into three and shared by the common circuit (1) 1610, the common circuit (2) 1620, and the common circuit (3) 1630 to calculate the SAD, a wider SAD calculation region can be achieved without increasing the processing ability of each common circuit, and the motion vector-can be calculated more accurately. Especially, this is an effective technique for calculating the motion vector of the P-picture, which has a greater motion vector than the B-picture.

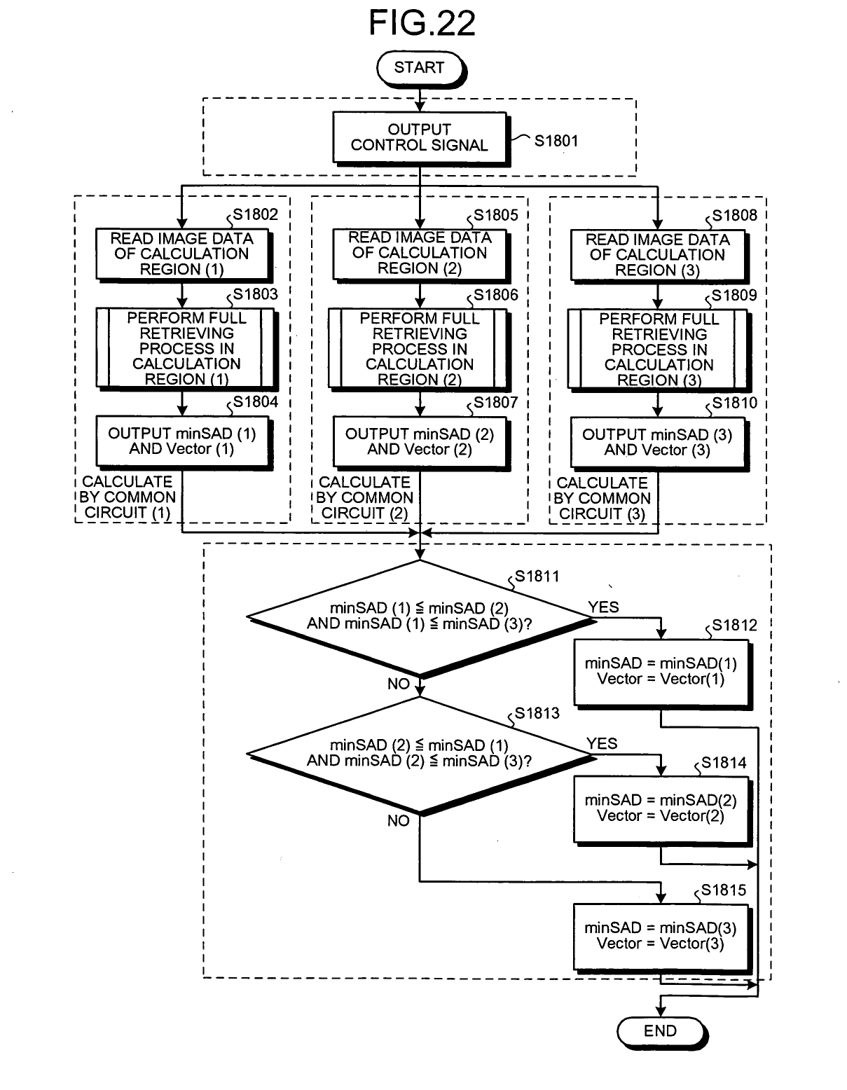

FIG. 22 is a flowchart of a motion vector calculation process by the motion vector calculation apparatus according to the fifth embodiment. The P-picture control unit 340 outputs control signals to the common circuit (1) 1610, the common circuit (2) 1620, and the common circuit (3) 1630 (step S1801).

The control signals are signals for setting the calculation regions and are, for example, signals that define the regions for calculating the SAD in the common circuit (1) 1610, the common circuit (2) 1620, and the common circuit (3) 1630 as the calculation region (1) 1701, the calculation region (2) 1702, and the calculation region (3) 1703 illustrated in FIG. 21 in the reference image in the temporally forward direction from the source image.

In accordance with the control signal input at step S1801, the common circuit (1) 1610 reads the image data of the calculation region (1) 1701 from the external memory 350 (step S1802). For, example, the reading of the image data is performed by a control unit, etc. not shown through the external memory interface 330.

Specifically, the external memory interface 330 performs an acquisition request to the external memory 350 for the image data of the calculation region (1) 1701. A cache memory, etc. not shown temporarily store the image data of the calculation region (1) 1701 input from the external memory 350 in accordance with the acquisition request.

The common circuit (1) 1610 uses the image data read at step S1802 to perform the full retrieving process of the calculation region (1) 1701 (step S1803).

Specifically, the image data stored temporarily in the cache memory are referenced to calculate the SAD that is image information of the source image and the calculation region. The smallest SAD (minSAD (1)) and the motion vector (Vector (1)) are calculated. Since details of the full retrieving process at step S1803 are substantially the same as shown in FIG. 10, the description thereof will be omitted by replacing (L) and (R) with (1), (2), and (3).

In this specification, the smallest SAD is the minSAD, and (1), (2), or (3) of the common circuit is added to the minSAD calculated by different common circuits. The calculated motion vector will be referred to as the Vector, and (1), (2), or (3) of the common circuit is added to the Vector calculated by different common circuits.

Specifically, the SAD and the minSAD calculated by the common circuit (1) are a SAD (1) and a minSAD (1), respectively; the SAD and the minSAD calculated by the common circuit (2) are a SAD (2) and a minSAD (2), respectively; and the SAD and the minSAD calculated by the common circuit (3) are a SAD (3) and a minSAD (3).

The Vector calculated by the common circuit (1) is Vector (1); the Vector calculated by the common circuit (2) is Vector (2); and the Vector calculated by the common circuit (3) is Vector (3).

The common circuit (1) 1610 outputs to the P-picture control unit 340 the minSAD (1) and the Vector (1) calculated in the full retrieving process at step S1803 (step S1804).

As is the case with steps S1802 to S1804, the common circuit (2) 1620 and the common circuit (3) 1630 read the image data of the calculation region (2) 1702 and the calculation region (3) 1703 from the external memory 350 (steps S1805 and S1808) and perform the full retrieving processes in the calculation region (2) 1702 and the calculation region (3) 1703 (steps S1606 and S1809).

The common circuit (2) 1620 and the common circuit (3) 1630 output the minSAD (2) and minSAD (3) and the Vector (2) and Vector (3) calculated in the full retrieving processes at steps S1806 and S1809 (steps S1807 and S1810).

The P-picture control unit 340 compares the minSAD (1), minSAD (2), and minSAD (3) output at steps S1804, S1807, and S1810.

Specifically, in FIG. 22, it is determined whether the minSAD (1) is the minSAD (2) or less and the min SAD (1) is the minSAD (3) or less (step S1811). In other words, it is determined whether the minSAD (1) calculated by the common circuit (1) 1610 is the smallest or not.

If the minSAD (1) is the minSAD (2) or less and the minSAD (1) is the minSAD (3) or less at step S1811 (step S1811: YES), the minSAD and the Vector are defined as the minSAD (1) and the Vector (1), respectively (step S1812), and a series of the processes is terminated.

In other words, when comparing the minSAD (1), minSAD (2), and minSAD (3), if the minSAD (1) is the smallest, the smallest SAD is defined as the minSAD (1) and the vector corresponding to the minSAD (1) is defined as the motion vector.

If the minSAD (1) is not the minSAD (2) or less or if the min SAD (1) is not the minSAD (3) or less at step S1811 (step S1811: NO), it is determined whether the minSAD (2) is the minSAD (1) or less and the min SAD (2) is the minSAD (3) or less (step S1812).

Specifically, since the minSAD (1) is not the smallest among the minSAD (1), minSAD (2), and minSAD (3) at step S1811, it is determined whether the minSAD (2) calculated by the common circuit (2) 1610 is the smallest or not.

If the minSAD (2) is the minSAD (1) or less and the minSAD (2) is the minSAD (3) or less at step S1813 (step S1813: YES), the minSAD and the Vector are defined as the minSAD (2) and the Vector (2), respectively (step S1814), and a series of the processes is terminated.

In other words, when comparing the minSAD (1), minSAD (2), and minSAD (3), if the minSAD (2) is the smallest, the smallest SAD is defined as the minSAD (2) and the vector corresponding to the minSAD (2) is defined as the motion vector.

If the minSAD (2) is not the minSAD (1) or less or if the minSAD (2) is not the minSAD (3) or less at step S1813 (step S1813: NO), the minSAD and the Vector are defined as the minSAD (3) and the Vector (3), respectively (step S1815), and a series of the processes is terminated.

In other words, when comparing the minSAD (1), minSAD (2), and minSAD (3), if the minSAD (3) is the smallest, the smallest SAD is defined as the minSAD (3) and the vector corresponding to the minSAD (3) is defined as the motion vector.

As described above, in the motion vector calculation process in FIG. 22, the motion vector can be calculated based on the smallest SAD among the calculation region (1) 1701, the calculation region (2) 1702, and the calculation region (3) 1703. In other words, the movement of the source image can be predicted by using the SAD with the smallest amount of change from the source image to calculate the motion vector.

Thus, according to the fifth embodiment, if two or more communication circuits are provided, the SAD can be calculated by sharing the calculation region in the reference image among a plurality of common circuits. Therefore, a circuit can be utilized efficiently without installing a calculation circuit additionally; the SAD can be calculated from a wider calculation region to calculate an appropriate motion vector; and higher image quality can be achieved in the entire moving image.

As described above, according to the present invention, image quality of a moving image can be improved with a simple circuit configuration without additionally installing a circuit for calculating a motion vector.

According to the embodiments of the present invention described above, it is possible to improve image quality of a moving image with a simple configuration.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A motion vector calculation apparatus that calculates a motion vector of a source image in a series of frame images constituting a moving image, based on the source image and at least one reference image that includes a forward image being a frame image positioned temporally forward and a backward image being a frame image positioned temporally backward to the source image in the series of the frame images, the motion vector calculation apparatus comprising:
a first calculating unit configured to calculate first information based on the source image and the forward image;
a second calculating unit configured to calculate second information based on the source image and the backward image;
a switching unit configured to switch the reference image from a bidirectional images including both the forward image and the backward image, to only the forward image, wherein
the second calculating unit is configured to calculate, when the reference image is switched by the switching unit, third information based on the source image and the forward image, the third information being different from the first information.

2. The motion vector calculation apparatus according to claim 1, wherein
the first calculating unit is configured to calculate the first information based on the source image and an image of a first calculation region in the forward image, and
the second calculating unit is configured to calculate the third information based on the source image and an image of a second calculation region in the forward image, the second calculation region being different from the first calculation region.

3. The motion vector calculation apparatus according to claim 2, further comprising a vector calculating unit configured to calculate the motion vector by comparing the first information and the third information to identify a destination of the source image in the forward image.

4. The motion vector calculation apparatus according to claim 1, wherein
the first calculating unit is configured to calculate the first information based on the source image and an image of a first calculation region within an arbitrary calculation region in the forward image, and
the second calculating unit is configured to calculate the third information based on the source image and an image of a second calculation region within the arbitrary image region, the second calculation region being different from the first calculation region.

5. The motion vector calculation apparatus according to claim 4, further comprising a vector calculating unit configured to calculate the motion vector by comparing the first information and the third information to identify a destination of the source image in the forward image.

6. The motion vector calculation apparatus of claim 4, wherein
the first calculating unit is configured to calculate the first information based on a sum of absolute difference between pixel values of the source image and pixel values of the first calculation region, and
the second calculating unit is configured to calculate the third information based on a sum of absolute difference between the pixel values of the source image and pixel values of the second calculation region.

7. The motion vector calculation apparatus according to claim 1, further comprising a third calculating unit configured to calculate, when the reference image is the bidirectional images, fourth information based on the source image and any one of the forward image and the backward image, wherein
the third calculating unit is configured to calculate, when the reference image is switched by the switching unit, fifth information based on the source image and the forward image, the fifth information being different from the first information and the third information.

8. The motion vector calculation apparatus according to claim 7, wherein
the first calculating unit is configured to calculate the first information based on the source image and an image of a first calculation region in the forward image,
the second calculating unit is configured to calculate the second information based on the source image and an image of a second calculation region in the forward frame, the second calculation region being different from the first calculation region, and
the third calculating unit is configured to calculate the fifth information based on the source image and an image of a third calculation region in the forward image, the third calculation region being different from the first calculation region and the second calculation region.

9. The motion vector calculation apparatus according to claim 7, further comprising a vector calculating unit configured to calculate the motion vector by comparing the first information, the third information, and the fifth information to identify a destination of the source image in the forward image.
